(19) United States
(12) Patent Application Publication
(10) Pub. No.: US 2025/0315985 A1
(43) Pub. Date: Oct. 9, 2025

(54) BASEMESH ENTROPY PACKETS IN VIDEO-BASED DYNAMIC MESH CODING (V-DMC)

(71) Applicant: Samsung Electronics Co., Ltd., Suwon-si (KR)

(72) Inventors: Madhukar Budagavi, Plano, TX (US); Rajan Laxman Joshi, San Diego, CA (US)

(21) Appl. No.: 19/172,575

(22) Filed: Apr. 7, 2025

Related U.S. Application Data
(60) Provisional application No. 63/631,169, filed on Apr. 8, 2024.
(60) Provisional application No. 63/634,131, filed on Apr. 15, 2024.
(60) Provisional application No. 63/668,662, filed on Jul. 8, 2024.
(60) Provisional application No. 63/669,591, filed on Jul. 10, 2024.
(60) Provisional application No. 63/682,174, filed on Aug. 12, 2024.
(60) Provisional application No. 63/682,590, filed on Aug. 13, 2024.
(60) Provisional application No. 63/691,809, filed on Sep. 6, 2024.

(51) Int. Cl. G06T 9/00; H04N 19/70

(52) U.S. Cl. CPC G06T 9/001; H04N 19/70

(57) ABSTRACT

An apparatus with a processor receives a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors for decoding a mesh frame. The processor decodes the syntax element and arithmetically decodes the first and second set of arithmetically coded prediction errors based on the syntax element. In one example, the first and second set of arithmetically coded prediction errors are included in a single entropy packet if the syntax element has a first value and the first set of arithmetically coded prediction errors is in a first entropy packet and the second set of arithmetically coded error predictions is in a second entropy packet if the syntax element has a second value.

### CROSS REFERENCE TO RELATED APPLICATION

This application claims benefit of U.S. Provisional Application No. 63/631,169 filed on Apr. 8, 2024; U.S. Provisional Application No. 63/634,131 filed on Apr. 15, 2024; U.S. Provisional Application No. 63/668,662 filed on Jul. 8, 2024; U.S. Provisional Application No. 63/669,591 filed on Jul. 10, 2024; U.S. Provisional Application No. 63/682,174 filed on Aug. 12, 2024; and U.S. Provisional Application No. 63/682,590 filed Aug. 13, 2024; U.S. Provisional Application No. 63/691,809 filed Sep. 6, 2024, in the United States Patent and Trademark Office, the entire contents of which are hereby incorporated by reference.

### TECHNICAL FIELD

The disclosure relates to improvements to video-based compression of dynamic meshes, and more particularly to, for example, but not limited to, improvements to entropy packets and packing of prediction errors, mesh connectivity information, and other basemesh syntax elements in a basemesh codec.

### BACKGROUND

Currently, International Organization for Standardization (ISO)/International Electrotechnical Commission (IEC) subcommittee 29 working group 07 (ISO/IEC SC29/WG07) is working on developing a standard for video-based compression of dynamic meshes. For example, the committee is working on a video-based dynamic mesh coding (V-DMC) standard that specifies syntax, semantics, and decoding for V-DMC, basemesh coding, Moving Picture Experts Group (MPEG) edgebreaker static mesh coding, and arithmetic coded displacement. In an embodiment, a Draft International Standard (DIS) of the V-DMC standard (V-DMC DIS), was established by the ISO/IEC SC29 WG07 in December 2024. Draft specification for video-based compression of dynamic meshes is also available.

In an example, a mesh is a basic element in a three-dimensional (3D) computer graphics model. In an embodiment, a mesh is composed of several polygons that describe a boundary surface of a volumetric object. In such embodiments, each polygon is defined by its vertices in a three-dimensional (3D) space and information on how the vertices are connected is referred to as connectivity information. Additionally, vertex attributes can be associated with the mesh vertices. For example, the vertex attributes can include colors, normal, etc. In some cases, attributes are also associated with the surface of the mesh by exploiting mapping information that describes a parameterization of the mesh onto two-dimensional (2D) regions of the plane. In some embodiments, such mapping is described by a set of parametric coordinates, referred to as (U, V) coordinates or texture coordinates. In some embodiments, if the connectivity or attribute information changes, the mesh is called a dynamic mesh. In some embodiments, dynamic meshes contain large amount of data and are therefore standardized by the MPEG.

In some examples, a basemesh has a smaller number of vertices compared to an original mesh. For example, the basemesh is created and compressed either in a lossy or lossless manner. In some embodiments, a reconstructed basemesh undergoes subdivision and then a displacement field between the original mesh and the subdivided reconstructed basemesh is calculated. In at least some embodiments, during inter coding of mesh frame, the basemesh is coded by sending vertex motions instead of compressing the basemesh directly.

However, there can be one or more errors associated with creating the basemesh—e.g., one or more prediction errors. For example, prediction errors of vertex attributes such as geometry errors, texture coordinate errors, material properties errors, or other vertex property errors. In some examples, the process of packing and transmitting the prediction errors can take up allocated resources in the system, specifically when transmitting each prediction error within their own respective entropy packets.

There can also be additional information related to a geometry or material attribute feature. For example, there can also be mesh connectivity information (e.g., handle data and CLERS symbols) and other basemesh syntax elements (e.g., material attribute seam information, duplicate vertices flag information, mesh attribute duplicate information, etc.). In some examples, packing the mesh connectivity information and other basemesh syntax elements also takes up additional allocated resources in the system, specifically when transmitting each type of mesh connectivity information or basemesh syntax element within their own respective entropy packets.

The description set forth in the background section should not be assumed to be prior art merely because it is set forth in the background section. The background section may describe aspects or embodiments of the present disclosure.

### SUMMARY

In some embodiments, this disclosure may relate to improvements to basemesh entropy coding. Specifically, for improvements related to packing prediction error information (e.g., geometry prediction errors or texture coordinates prediction error), mesh connectivity information (e.g., mesh handles data, CLERS symbols), and/or other basemesh syntax elements (e.g., duplicate vertex information, seams data, etc.) in entropy packets for a basemesh codec.

An aspect of the present disclosure provides for an apparatus for decoding a mesh frame, comprising a processor configured to cause: receive a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors for the mesh frame, decode the syntax element, and arithmetically decode the first set of arithmetically coded prediction errors and the second set of arithmetically coded prediction errors based on the syntax element, wherein the first set of arithmetically coded prediction errors and the second set of arithmetically coded prediction errors are included in the single entropy packet if the syntax element has a first value and the first set of arithmetically coded prediction errors is in a first entropy packet of the plurality of entropy packets and the second set of arithmetically coded prediction errors is in a second entropy packet of the plurality of entropy packets if the syntax element has a second value.

In an embodiment, the bitstream further includes a second syntax element indicating a size of the first entropy packet if the syntax element has the second value, the processor is further configured to cause determine a variable pointing to a current position in the first entropy packet based on the second syntax element, wherein the first set of arithmetically coded prediction errors is decoded based on the variable.

In some embodiments, the bitstream further includes a second syntax element indicating a size of the single entropy packet if the syntax element has the first value, the processor is further configure to cause determine a variable pointing to a current position in the single entropy packet based on the second syntax element, wherein the first set of arithmetically coded prediction errors and the second set of arithmetically coded prediction errors are decoded based on the variable.

In at least one embodiment, a prediction error for a current vertex is determined by arithmetically decoding one of the first set of arithmetically coded prediction errors and the processor is further configured to cause determine a prediction value for the current vertex and determine a coordinate value of the current vertex based on the prediction error for the current vertex and the prediction value for the current vertex.

In one or more embodiments, the bitstream further includes a second syntax element associated with the first set of arithmetically coded prediction errors if the syntax element has the second value, the processor is further configured to cause decode the second syntax element and arithmetically decode the first set of arithmetically coded prediction errors based on the second syntax element, wherein the first set of arithmetically coded prediction errors are decoded without an arithmetic operation syntax element if the second syntax element has a third value, and the first set of arithmetically coded prediction errors are decoded after decoding the arithmetic operation syntax element if the second syntax element has a fourth value.

In some embodiments, the bitstream further includes a second syntax element associated with the second set of arithmetically coded prediction errors if the syntax element has the second value, the processor is further configured to cause decode the second syntax element and arithmetically decode the second set of arithmetically coded prediction errors based on the second syntax element, wherein the second set of arithmetically coded prediction errors are decoded without an arithmetic operation syntax element if the second syntax element has a third value and the second set of arithmetically coded prediction errors are decoded after decoding the arithmetic operation syntax element if the second syntax element has a fourth value.

In some embodiments, the first set of arithmetically coded prediction errors is at least one of a fine geometry prediction error or a coarse geometry prediction error.

In at least one embodiment, the second set of arithmetically coded prediction errors is at least one of a fine texture prediction error, a coarse texture prediction error, a fine material property prediction error, a coarse material property prediction error, a normal prediction error, or a material identification prediction error.

In one or more embodiments, the first set of prediction errors includes at least a fine geometry prediction error and a coarse geometry prediction error and the second set of prediction errors includes at least a fine texture coordinate error and a coarse texture coordinate error.

In some embodiments, the bitstream further includes the mesh connectivity information and the additional basemesh syntax elements, the processor is further configured to cause decode the mesh connectivity information and the additional basemesh syntax elements, wherein the mesh connectivity information, the additional basemesh syntax elements, the first set of arithmetically coded prediction errors, and the second set of arithmetically coded prediction errors are included in the single entropy packet if the syntax element has the first value and the mesh connectivity information is in a third entropy packet of the plurality of entropy packets and the additional basemesh syntax elements are in a fourth entropy packet of the plurality of entropy packets if the syntax element has the second value.

An aspect of the present disclosure provides for an apparatus for encoding a mesh frame, comprising a processor configured to cause: determine a first set of prediction errors and a second set of prediction errors for the mesh frame; arithmetically encode the first set of prediction errors and the second set of prediction errors based on a value of a syntax element indicating whether prediction errors, mesh connectivity information, and additional basemesh syntax elements are transmitted in a single entropy packet or a plurality of entropy packets; and transmit a bitstream including the first set of arithmetically coded prediction errors, the second set of arithmetically coded prediction errors, and the syntax element, wherein the first set of arithmetically coded prediction errors and the second set of arithmetically coded prediction errors are transmitted in the single entropy packet if the syntax element has a first value and the first set of arithmetically coded prediction errors is transmitted in a first entropy packet of the plurality of entropy packets and the second set of arithmetically coded prediction errors is transmitted in a second entropy packet of the plurality of entropy packets.

In an embodiment, the processor is further configured to cause encode a variable pointing to a current position in the first entropy packet if the syntax element has the second value and transmit the variable in a second syntax element indicating a size of the first entropy packet, wherein the first set of prediction errors is encoded based on the variable.

In one or more embodiments, the processor is further configured to cause encode a variable pointing to a current position in the single entropy packet if the syntax element has the first value and transmit the variable in a second syntax element indicating a size of the single entropy packet, wherein the first set of prediction errors and the second set of prediction errors are encoded based on the variable.

In at least one embodiment, the processor is further configured to cause encode a second syntax element associated with the first set of prediction errors, wherein the processor is to arithmetically encode the first set of prediction errors based on encoding the second syntax element and transmit the bitstream including the second syntax element, wherein the first set of arithmetically coded prediction errors is encoded without an arithmetic operation syntax element if the second syntax element has a third value and the first set of arithmetically coded prediction errors is encoded with the arithmetic operation syntax element if the second syntax element has a fourth value.

In some embodiments, the processor is further configured to cause encode a second syntax element associated with the second set of prediction errors, wherein the processor is to arithmetically encode the second set of prediction errors based on encoding the second syntax element and transmit the bitstream including the second syntax element, wherein the second set of arithmetically coded prediction errors is encoded without an arithmetic operation syntax element if the second syntax element has a third value and the second set of arithmetically coded prediction errors is encoded with the arithmetic operation syntax element if the second syntax element has a fourth value.

In some examples, the first set of prediction errors includes at least one of a fine geometry prediction error or a coarse geometry prediction error.

In some embodiments, the second set of prediction errors includes at least one of a fine texture prediction error, a coarse texture prediction error, a fine material property prediction error, a coarse material property prediction error, a normal prediction error, or a material identification prediction error.

In one or more embodiments, the first set of prediction errors includes at least a fine geometry prediction error and a coarse geometry prediction error and the second set of prediction errors includes at least a fine texture coordinate error and a coarse texture coordinate error.

In at least one embodiment, the processor is further configured to cause determine the mesh connectivity information and the additional basemesh syntax elements and transmit the bitstream including the mesh connectivity information and the additional basemesh syntax elements, wherein the mesh connectivity information, the additional basemesh syntax elements, the first set of arithmetically coded prediction errors, and the second set of arithmetically coded prediction errors are transmitted in the single entropy packet if the syntax element has the first value and the mesh connectivity information is transmitted in a third entropy packet of the plurality of entropy packets and the additional basemesh syntax elements are transmitted in a fourth entropy packet of the plurality of entropy packets.

An aspect of the present disclosure provides for a method for decoding a mesh frame, comprising: receiving, at a processor for decoding a mesh frame, a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors for the mesh frame; decoding the syntax element; arithmetically decoding the first set of arithmetically coded prediction errors and the second set of arithmetically coded prediction errors based on the syntax element, wherein the first set of arithmetically coded prediction errors and the second set of arithmetically coded prediction errors are included in the single entropy packet if the syntax element has a first value; and the first set of arithmetically coded prediction errors is in a first entropy packet of the plurality of entropy packets and the second set of arithmetically coded prediction errors is in a second entropy packet of the plurality of entropy packets if the syntax element has a second value.

### BRIEF DESCRIPTION OF THE DRAWINGS

FIG. 1 illustrates an example communication system 100 in accordance with an embodiment of this disclosure.

FIGS. 2 and 3 illustrate example electronic devices in accordance with an embodiment of this disclosure.

FIG. 4 illustrates a block diagram for an encoder encoding intra frames in accordance with an embodiment.

FIG. 5 illustrates a block diagram for a decoder in accordance with an embodiment.

FIGS. 6 and 7 illustrate a block diagram of parallelogram mesh predictions in accordance with an embodiment.

FIG. 8 illustrates an example entropy packet in a basemesh codec in accordance with an embodiment.

FIG. 9 illustrates an example syntax of elements for entropy packet encoding in a basemesh codec in accordance with an embodiment.

FIGS. 10-12 illustrate example simplified entropy packets in accordance with an embodiment.

FIG. 13 illustrates an entropy packet of a basemesh codec in accordance with an embodiment.

FIGS. 14-20 illustrate example data packets including entropy packets of a basemesh codec in accordance with an embodiment.

FIG. 21 illustrates an example flow chart of encoding entropy packets in a basemesh codec in accordance with an embodiment.

FIG. 22 illustrates an example flow chart of decoding entropy packets in a basemesh codec in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

In some embodiments, three hundred sixty degree (360°) video and three-dimensional (3D) volumetric video are emerging as new ways of experiencing immersive content due to the ready availability of powerful handheld devices such as smartphones. In some embodiments, while 360° video enables immersive “real life,” “being there” experience for consumers by capturing the 360° outside-in view of the world, 3D volumetric video can provide a complete “six degrees of freedom” (6DoF) experience of being and moving within the content. In some examples, users can interactively change their viewpoint and dynamically view any part of the captured scene or object they desire. Display and navigation sensors can track head movement of the user in real-time to determine the region of the 360° video or volumetric content that the user wants to view or interact with. Multimedia data that is three-dimensional (3D) in nature, such as point clouds or 3D polygonal meshes, can be used in the immersive environment.

In an embodiment, a point cloud is a set of 3D points along with attributes such as color, normal, reflectivity, point-size, etc. that represent an object's surface or volume. In some examples, point clouds are common in a variety of applications such as gaming, 3D maps, visualizations, medical applications, augmented reality, virtual reality, autonomous driving, multi-view replay, 6DoF immersive media, to name a few. In at least some examples, uncompressed point clouds generally require a large amount of bandwidth for transmission. Accordingly, due to the large bitrate requirement, point clouds are often compressed prior to transmission. In at least one example, compressing a 3D object such as a point cloud, often requires specialized hardware. To avoid specialized hardware to compress a 3D point cloud, a 3D point cloud can be transformed into traditional two-dimensional (2D) frames and that can be compressed and later be reconstructed and viewable to a user.

In an embodiment, Polygonal 3D meshes, especially triangular meshes, are another popular format for representing 3D objects. Meshes typically include a set of vertices, edges and faces that are used for representing the surface of 3D objects. Triangular meshes are simple polygonal meshes in which the faces are simple triangles covering the surface of the 3D object. In some examples, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

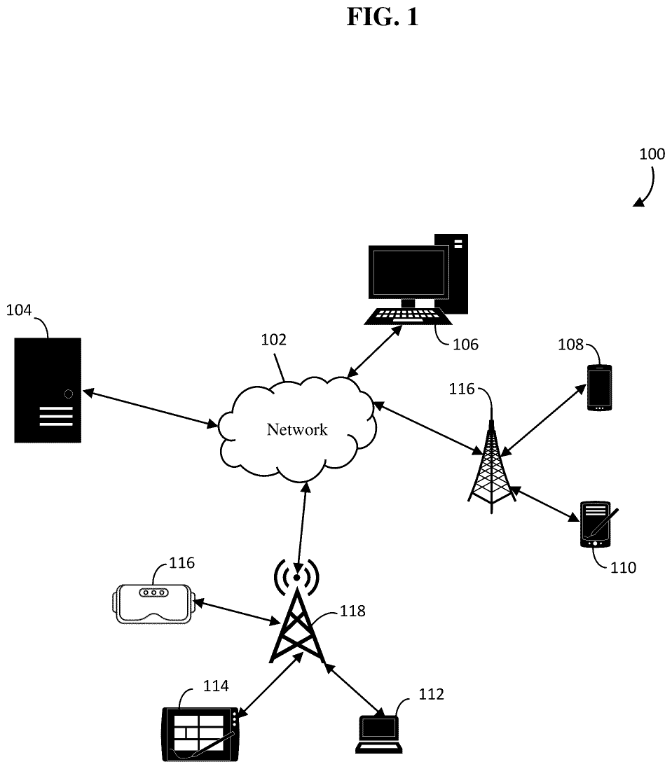

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

In an embodiment, communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a head mounted display (HMD) device, or the like. In some examples, server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include, but are not limited to, a desktop computer 106, a mobile telephone or mobile device 108 (such as a smartphone), a personal digital assistance (PDA) 110, a laptop computer 112, a tablet computer 114 (e.g., with a touchscreen or stylus), and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In an embodiment, HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations (e.g., BS) 118, such as cellular base stations or eNodeBs (eNBs) or a fifth generation (5G) base station implementing new radio (NR) technology or gNodeB (gNb). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a virtual reality (VR) display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can then compress 3D point cloud or mesh to generate a bitstream and then transmit the bitstream to one or more of the client devices 106-116. For another example, one of the client devices 106-116 can compress a 3D point cloud or mesh to generate a bitstream and then transmit the bitstream to another one of the client devices 106-116 or to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

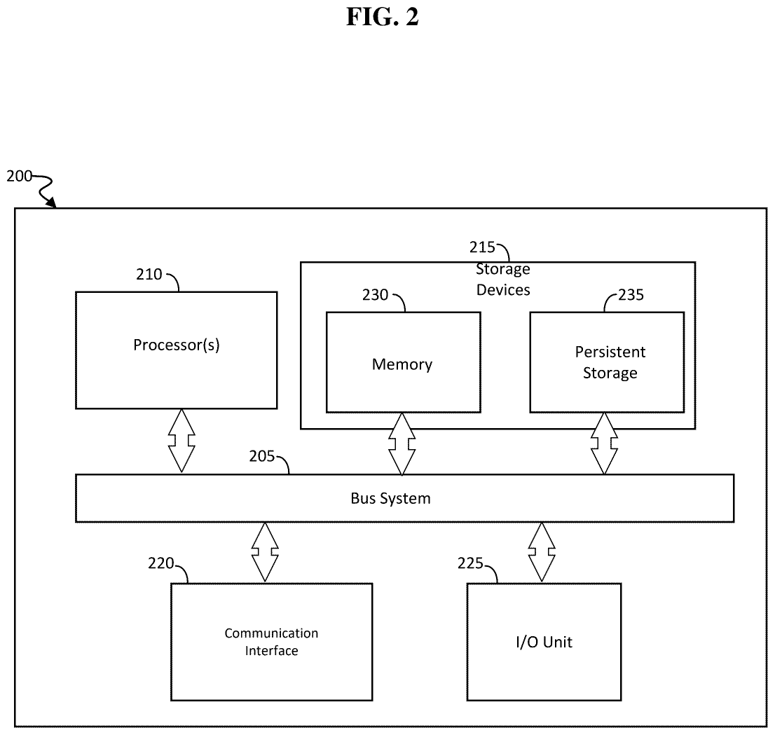

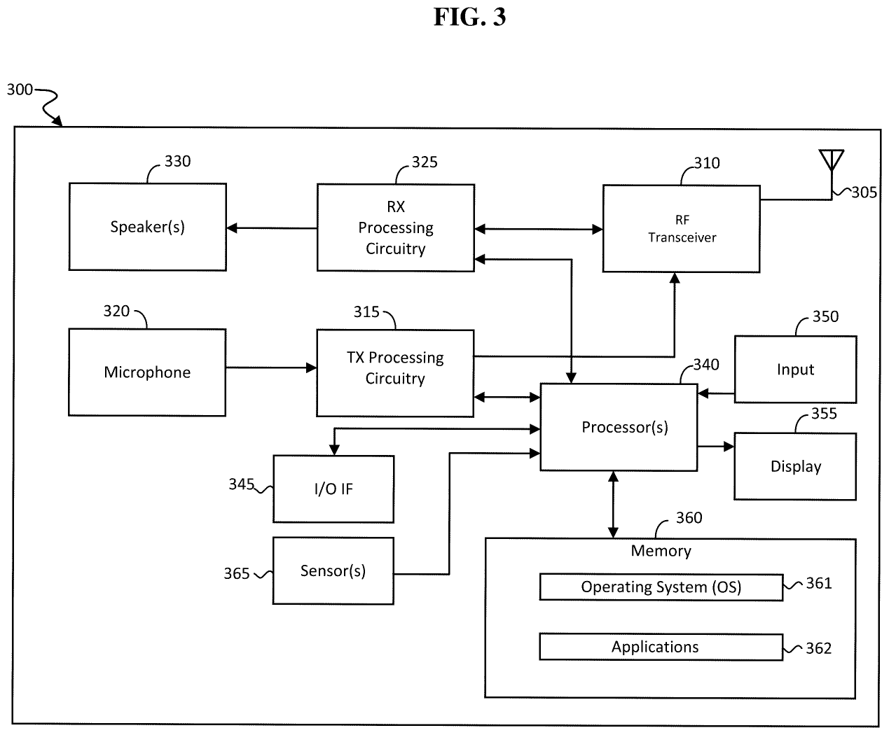

FIGS. 2 and 3 illustrate example electronic devices in accordance with an embodiment of this disclosure. In particular, FIG. 2 illustrates an example server 200, and the server 200 could represent the server 104 as described with reference to FIG. 1. In an embodiment, the server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

In an embodiment, the RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or augmented reality (AR) application (e.g., a device from the field of Extended Reality (XR)), a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a random access memory (RAM), and another part of the memory 360 could include a Flash memory or other read only memory (ROM). The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Additionally, the ISO/IEC SC29/WG07 is currently working on developing a standard for video-based compression of dynamic meshes. In an embodiment, V-DMC DIS represents a current state of the standard, established on December 2024 by the ISO/IEC SC29/WG07. In at least one embodiment, a software implementation of V-DMC DIS is available in a form of software from a git repository. In some embodiments, a committee draft (CD) specification for video-based compression of dynamic meshes is also available.

The following documents are hereby incorporated by reference into the present disclosure as if fully set forth herein: i). V-DMC 8.0, ISO/IEC SC29 WG07 N00874, June 2024; ii). CD of V-DMC, ISO/IEC SC29 WG07 N00885, June 2024; iii). V-DMC DIS, ISO/IEC SC29 WG07 N01027, December 2024; and iv) Study of technologies for Video-based mesh coding, ISO/IEC SC29 WG07 N00960, August 2024.

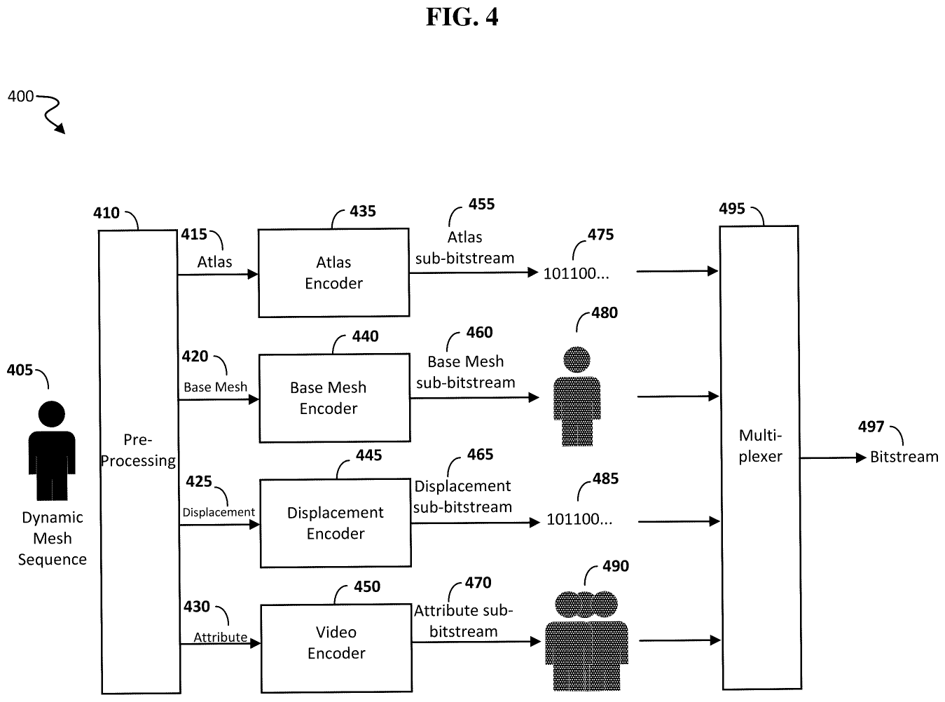

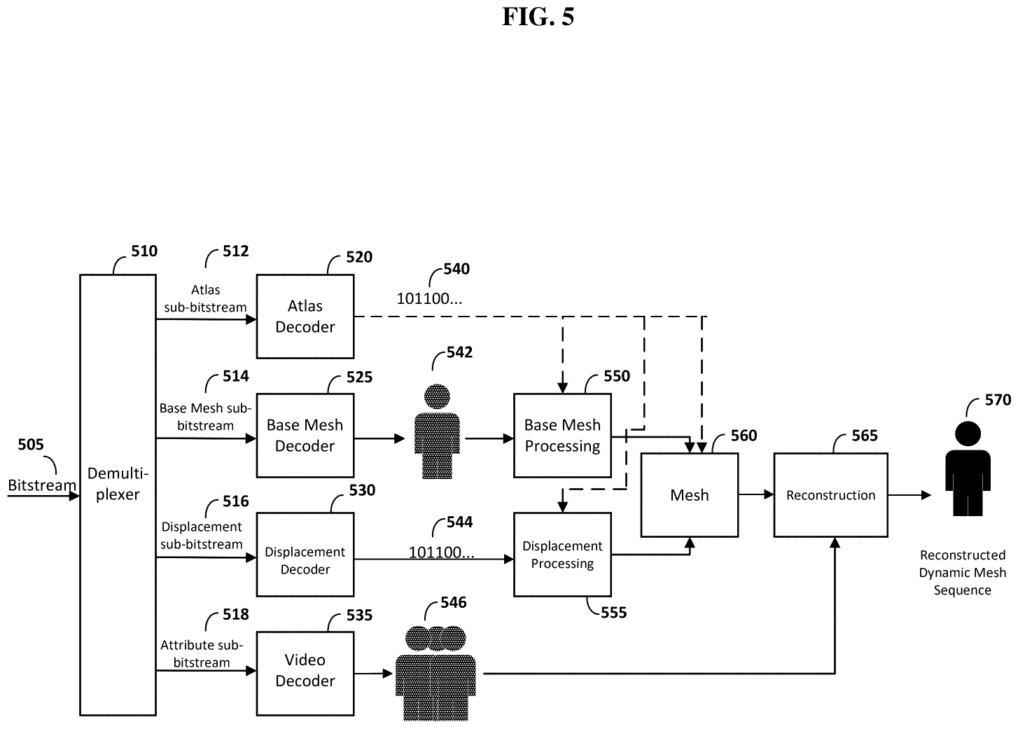

FIGS. 4 and 5 illustrate block diagrams for a V-DMC encoder and decoder, respectively.

As shown in FIG. 4, system 400 can include pre-processing unit 410 in communication with one or more encoders (e.g., in communication with an atlas encoder 435, a basemesh encoder 440, a displacement encoder 445, and a video encoder 450). In one embodiment, system 400 illustrates an encoding of a dynamic mesh sequence 405 being multiplexed and transmitted as a visual volumetric video-based encoding (V3C) bitstream 497. In an embodiment, for each mesh frame, the system 400 can create a basemesh 420, which can include a lesser number of vertices compared to an original mesh. In one embodiment, the basemesh is compressed either in a lossy or lossless manner to create a basemesh sub-bitstream 460. In one embodiment, the basemesh 420 is intra coded—e.g., coded without prediction from neighboring basemesh frames. In other embodiments, the baes-mesh 420 is inter coded—e.g., coded with predictions from neighboring basemesh frames. In one embodiment, a reconstructed basemesh undergoes subdivision and then a displacement field between the original mesh and the subdivided reconstructed basemesh is calculated, compressed, and transmitted.

For example, the pre-processing unit 410 can receive a dynamic mesh sequence 405. In at least one embodiment, the pre-processing unit 410 can convert the dynamic mesh sequence 405 into components: atlas 415, basemesh 420, displacement 425, and attributes 430. That is, the dynamic mesh sequence 405 can include information about connectivity, geometry, mapping, vertex attributes, and attribute maps. In some embodiments, connectivity information refers to connections between vertexes of the dynamic mesh sequence 405. In some examples, geometric information refers to a position of each vertex in a 3D space, represented as coordinates. In some examples, attribute 430 information includes information about color, material information, normal direction, texture coordinates, etc., of the vertexes or a mesh face. In at least one embodiment, the dynamic mesh sequence 405 can be referred to as dynamic if one or more of the connectivity, geometry, mapping, vertex attribute, and/or attribute maps change.

In at least one embodiment, the pre-processing unit 410 can receive the dynamic mesh sequence 405 and transmit various portions of the dynamic mesh sequence to a plurality of encoders. For example, the dynamic mesh sequence 405 can include an atlas 415 portion that is pre-processed and transmitted to the atlas encoder 435. In one embodiment, the atlas 415 refers to a collection of two-dimensional (2D) bounding boxes and their associated information placed onto a rectangular frame and corresponding to a volume in a three-dimensional (3D) space on which volumetric data is rendered and a list of metadata corresponding to a part of a surface of a mesh in 3D space. In some embodiments, the atlas 415 can include information about geometry (e.g., depth) or texture (e.g., texture atlases). In at least one embodiment, the system 400 can utilize the metadata of atlas 415 to generate the bitstream 497. For example, the atlas 415 component provides information on how to perform inverse reconstruction—e.g., the atlas 415 can describe how to perform the subdivision of basemesh 420, how to apply displacement 425 vectors to the subdivided mesh, or how to apply the attributes 430 to the reconstructed mesh.

In at least one embodiment, the basemesh 420 can be referred to as a simplified low-resolution approximation of the original mesh, encoded using any mesh codec.

In at least one embodiment, the displacement 425 information provides displacement vectors that can be encoded as VC3 geometry video components using any video codec.

In some embodiments, attributes 430 provide additional properties and can be encoded by any video codec.

In an embodiment, the pre-processing unit 410 can create a basemesh 420 from the dynamic mesh sequence 405. In one embodiment, the pre-processing unit 410 can convert an original mesh into the basemesh based on a series of displacements 425 according to an attribute 430 map. For example, the original dynamic mesh sequence 405 can be down sampled to reduce a number of vertexes—e.g., to create a decimated mesh. In at least one embodiment, the decimated mesh undergoes re-parameterization through an application of the atlas 415 information and the atlas encoder 435 to generate the basemesh 420. In at least one embodiment, a subdivision is then applied to the basemesh 420 based in part on the displacement 425 information.

In at least one embodiment, the atlas encoder 435 generates an atlas sub-bitstream 455, a basemesh encoder 440 generates a basemesh sub-bitstream 460 and video encoder 450 generates attribute sub-bitstream 470. In at least one embodiment, the sub-bitstreams are multiplexed at multiplexer 495 to generate and transmit the bitstream 497.

FIG. 5 illustrates a block diagram for a decoder in accordance with an embodiment.

As shown in FIG. 5, system 500 can include a demultiplexer 510 in communication with one or more decoders (e.g., in communication with an atlas decoder 520, a basemesh decoder 525, a displacement decoder 530, and a video decoder 535). In one embodiment, system 500 illustrates a decoding of a visual volumetric video-based encoding (V3C) bitstream 505 into a reconstructed dynamic mesh sequence 570. In an embodiment, the system 500 decodes the basemesh sub-bitstream 514 to form a reconstructed basemesh 542. In some embodiments, the reconstructed basemesh 542 undergoes subdivision in the decoder. In at least one embodiment, a received displacement field is decompressed and added to the reconstructed basemesh to generate a final reconstructed mesh in the decoder.

For example, the demultiplexer 510 can receive a bitstream 505 and determine an atlas sub-bitstream 512, a basemesh sub-bitstream 514, a displacement sub-bitstream 516, and an attribute sub-bitstream 518. In at least one embodiment, an atlas decoder 520 processes the atlas sub-bitstream 512 information and transmits the decoded information to the basemesh processing 550. In some embodiments, the basemesh decoder 525 decodes the basemesh sub-bitstream 514 information to generate the reconstructed basemesh 542. In at least one embodiment, the displacement decoder 530 can decompress the displacement sub-bitstream 516 information and transmit the decoded bits 544 to a displacement processing unit 555. In at least one embodiment, system 500 reconstructs the mesh 560 by processing the basemesh 542, the decompressed atlas sub-bitstream 512 information and using the output of the processing and the displacement information generated by displacement processing 555 to generate the reconstructed mesh 565. In at least one embodiment, video decoder 535 can decompress the attribute sub-bitstream 518 information and transmit the information to the reconstruction unit 565. In at least one embodiment, the reconstruction unit 565 can generate the reconstructed dynamic mesh sequence 570 based on the reconstructed mesh 560 and the attribute information 546.

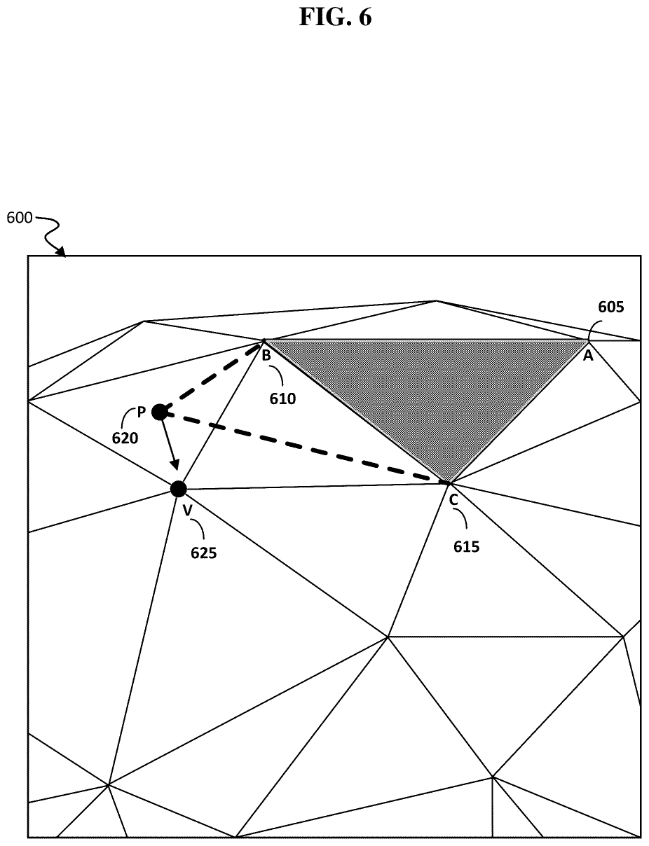

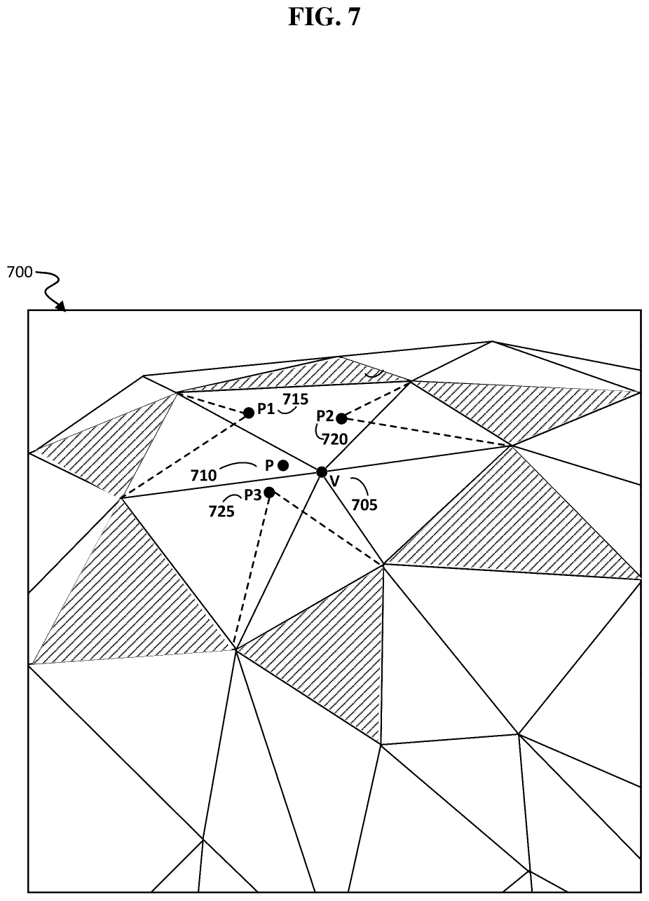

In at least one embodiment, FIGS. 6 and 7 illustrate example parallelogram mesh predictions. In at least one embodiment FIGS. 6 and 7 illustrate a basemesh that is intra coded—e.g., coded with predictions from neighboring vertices in the same basemesh frames. For example, as shown in FIG. 6, a vertex position is predicted based off a position of available neighboring vertices. In one embodiment, a vertex “V” 625 is predicted. In such examples, a predictor “P” 620 of “V” 625 is calculated from available neighboring vertices, vertex 605 “A”, vertex 610 “B”, and vertex 615 “C.” In one embodiment, available neighboring vertices can refer to vertices already transmitted. For example, a triangle (e.g., the shaded region) composed of vertex 605 “A”, vertex 610 “B”, and vertex 615 “C” may already be transmitted at a time a prediction for predictor “P” 620 is made.

In one embodiment, a parallelogram prediction algorithm is used. In other embodiments, a different predictor can be used, e.g., average value of available vertices, previous vertex, left vertex, right vertex, etc. In one embodiment where parallelogram prediction is used, the predictor “P” 620 is determined from the following equation (equation 1):

$$P = B + C - A$$

In at least one embodiment, a geometry prediction error “D” is determined by taking a difference between vertex “V” 625 and the predictor “P” 620 as shown in the following equation (equation 2):

$$D = V - P$$

In some embodiments, the prediction error is calculated and transmitted. In at least one embodiment, each vertex is represented by a three-dimensional coordinate (e.g., in X, Y, Z geometric coordinates).

In some embodiments, multiple parallelograms can be predicted, as illustrated in FIG. 7. For example, predictor “P1” 715, predictor “P2” 720, predictor “P3” 725 are calculated from vertices of three neighboring triangles (e.g., already transmitted triangles shown as the shaded regions in FIG. 7) using parallelogram prediction. In at least one embodiment, a final predictor “P” 710 is calculated as an average of predictor “P1” 715, predictor “P2” 720, and predictor “P3” 725. In at least one embodiment, a geometric error associated with the parallelogram prediction shown in FIG. 7 is determined by equation 2 shown above. In at least one embodiment, determining the prediction error occurs at the basemesh encoder 440 as described with reference to FIG. 4 or the basemesh decoder 525 as described with reference to FIG. 5.

As described with reference to FIGS. 6 and 7, a prediction error can be calculated and transmitted based on generating the basemesh. In at least some embodiments, the prediction errors are encoded (e.g., at an entropy coder or arithmetic encoder) and then transmitted. In at least some embodiments, the prediction error value is converted to a positive number determined prior to the encoding—e.g., non-positive integers (e.g., x≤0 is mapped to an odd integer −2x+1, while a positive integer (e.g., x>0) is mapped to an even integer 2x, as indicated in Table 1.1 in the V-DMC DIS. In at least one embodiment, the prediction error is coded using an arithmetic coding scheme to generate a prediction error codeword that is transmitted.

In some embodiments, there can be multiple different types of prediction errors. For example, there can be a geometry prediction error as described with reference to FIGS. 6 and 7. In one example, in V-DMC DIS, the geometric prediction error is classified into two categories, “fine” and “coarse.” In one embodiment, a “fine” category refers to vertices that are a part of at least one parallelogram, which all three remaining vertices being available (e.g., already transmitted). In some embodiments, a “coarse” category refers to remaining vertices (e.g., with one or two available vertex neighbors, or on a boundary, etc.). In at least one embodiment, no explicit symbol is associated with either category (e.g., with either “fine” or “coarse”). In such embodiments, a category can be inferred from neighborhood information (e.g., whether the remaining vertices are available or not).

In one embodiment, there can be multiple different types of prediction errors. As one example, in V-DMC, material properties (e.g., texture coordinates) are transmitted for each vertex (e.g., each vertex as described with reference to FIGS. 6 & 7). In some embodiments, a texture coordinate maps the vertex to a two-dimensional (2D) position in a texture image, which is then used for texture mapping while rendering three-dimensional (3D) objects. In at least one embodiment, the two-dimensional position in the texture image is typically represented by (U, V) coordinates. In some embodiments, the texture coordinates are predicted from texture coordinates and geometry coordinates of available neighboring vertices. In one example, a prediction error (e.g., an actual texture coordinate (T) minus the predicted texture coordinate (M), Texture Prediction Error=T−M) is determined and transmitted. In at least one embodiment, the texture prediction error is classified into a “fine” category and a “coarse” category—e.g., a “fine” category refers to vertices that are a part of at least one parallelogram, which all three remaining vertices being available (e.g., already transmitted) and a “coarse” category refers to remaining vertices (e.g., with one or two available vertex neighbors, or on a boundary, etc.). In at least one embodiment, no explicit symbol is associated with either category (e.g., with either “fine” or “coarse”). In such embodiments, a category can be inferred from neighborhood information (e.g., whether the remaining vertices are available or not). In some embodiments, the prediction error can be an example of a material property prediction or a normal prediction error.

In at least one embodiment, a prediction error value of a texture coordinate prediction error is converted into a positive number determine prior to the encoding. For example, a non-positive integer (e.g., x≤0) is mapped to an odd integer −2x+1, while a positive integer (e.g., x>0) is mapped to an even integer 2x as indicated in Table 1.1 in the V-DMC DIS. In at least one embodiment, the texture coordinate prediction error is coded using a binary arithmetic coding scheme—e.g., that is the prediction error for the texture coordinate prediction error has a format similar to the format described of the geometry prediction error.

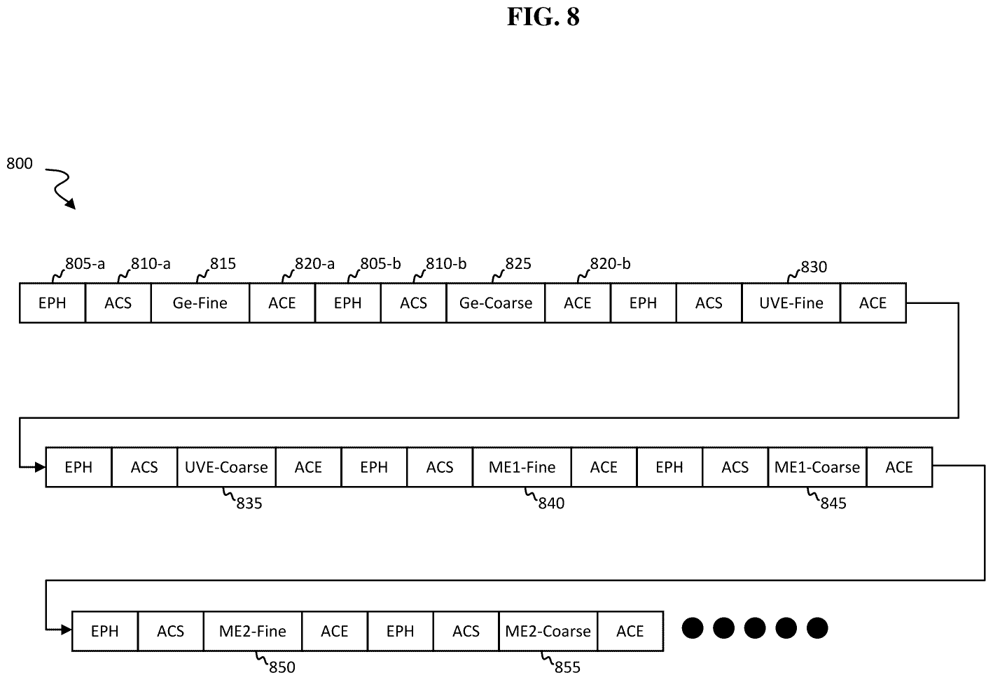

FIG. 8 illustrates an example entropy packet in video-based dynamic mesh coding (V-DMC). In at least one embodiment, packets 800 have a format indicated in V-DMC TMM 7.0. The packets 800 can be used to transmit one or more prediction errors (e.g., the prediction errors discussed with reference to FIGS. 6 and 7).

In one embodiment, packets 800 can include an entropy packet header (EPH 805) that includes an entropy packet length. In some examples, the packets 800 can include an arithmetic coding start/initialization (ACS 810) and an arithmetic coding stop/end (ACE 820). The packets 800 can be used to transmit one or more prediction errors. In one embodiment, the prediction errors can include geometry prediction errors, texture coordinates (UV) prediction errors, or material property prediction errors. In some embodiments, the prediction errors can belong to a “fine” category or a “coarse” category as described with reference to FIGS. 6 and 7. For example, the prediction errors can include a “fine” category of geometry prediction error samples (Ge-Fine 815), a “coarse” category of geometry prediction error samples (Ge-Coarse 825), a “fine” category of texture coordinates prediction error samples (UVE-Fine 830), a “coarse” category of texture coordinates prediction error samples (UVE-Coarse 835), a “fine” category of a first material property prediction error sample (ME1-Fine 840), a “coarse” category of the first material property prediction error sample (ME2-Coarse 845), a “fine” category of a second material property prediction error sample (ME2-Fine 850), or a “coarse” category of the second material property prediction error sample (ME2-Fine 845).

In one embodiment, each category of prediction error is coded in its own entropy packet. For example, the “fine” category of geometry prediction error samples can be sent in a first entropy packet and the “coarse” category of geometry prediction error samples can be sent in a second entropy packet. In such examples, the arithmetic coding is initialized at the beginning (e.g., as indicated by ACS 810) and stopped in the end (e.g., as indicated by ACE 820). In such examples, the first packet can include EPH 805-a indicating the first packet length, an ACS 810-a initializing the arithmetic coding, the Ge-Fine 815 prediction error for the “fine” category of geometry prediction error samples, and an ACE 820-a stopping the arithmetic coding. Additionally, the second packet can include an EPH 805-b indicating the second packet length, an ACS 810-b initializing the arithmetic coding of the second packet, the Ge-Coarse 820 prediction error for the “coarse” category of geometry prediction error samples, and an ACE 820-b stopping the arithmetic coding for the second packet.

In at least one embodiment, having each prediction error encoded in their own respective entropy packets enables random access to individual packets for parallel entropy decoding. However, the format of packets 800 can also cause a loss in coding efficiency because the arithmetic coding is reset at the beginning of each packet and additional bits are utilized to stop entropy coding at the end of the packet. In some embodiments, additional bits are also used in signaling the length of the entropy packet. Accordingly, it is sometimes desirable to enable/disable the use of entropy packets as described herein. In at least one embodiment, the entropy packets can be enabled or disabled based on a trade-off of performing parallel decoding and compression efficiency. In at least one embodiment, disabling the entropy packets can refer to packing all of the prediction errors, mesh connectivity information, and other basemesh syntax element within a single packet instead of having an individual packet for each respective type of prediction error.

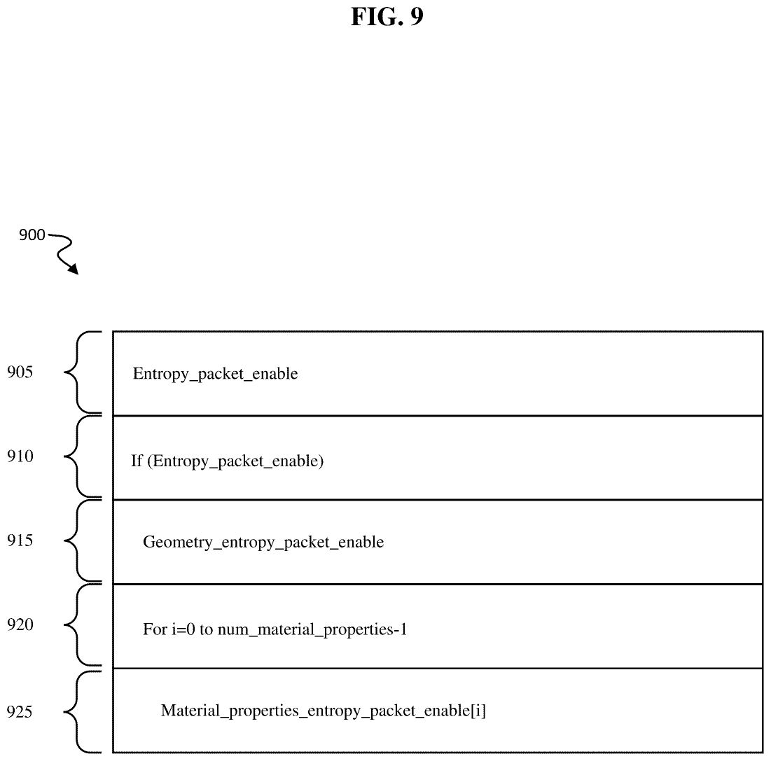

FIG. 9 illustrates an example of syntax of elements for entropy packet encoding in video-based dynamic mesh coding (V-DMC) in accordance with an embodiment.

As described with reference to FIG. 8, in some embodiments, a use of entropy packets can be enabled or disabled. In at least one embodiment, the entropy packets can be enabled or disabled by a set of syntax elements 900 as illustrated in FIG. 9. It should be noted that a naming convention of syntax elements 900 is for illustrative purposes only. The syntax elements 900 can have alternative names, can be ordered differently, or can be conditioned differently. That is, for example the field 915 (e.g., enabling or disabling geometry entropy packets (geometry_entropy_packet_enable)) could be sent directly without being conditioned on field 905 (e.g., not conditioned on the entropy packet enable feature (entropy_packet_enable)).

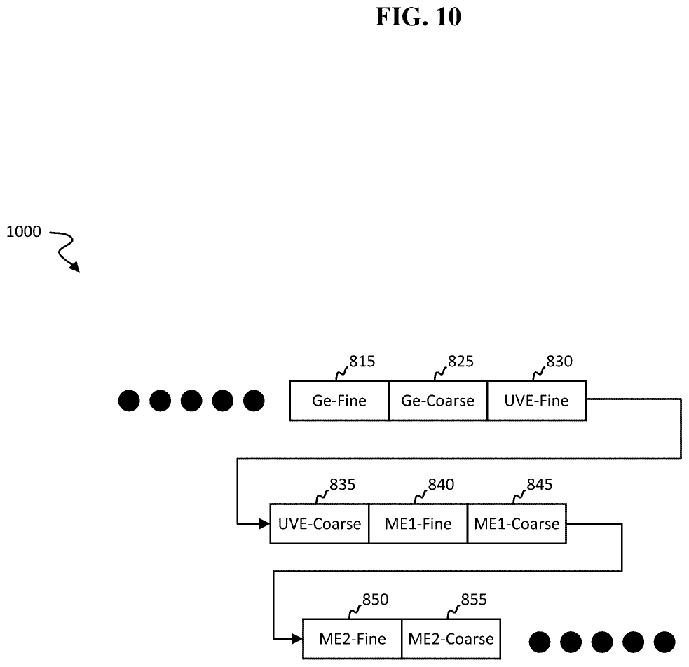

In at least some embodiments, enabling or disabling the syntax elements 900 can cause different features to be enabled with regards to transmitting the prediction errors. In at least one embodiment, disabling and enabling syntax elements 900 is described with reference to FIGS. 10-12, illustrating possible example formats of the prediction error.

For example, in one embodiment, the syntax element 905 can include syntax element entropy_packet_enable. In one embodiment, when the syntax element entropy_packet_enable is set to one (“1”), entropy packets for each different type of prediction errors is used as described with reference to FIG. 8. In some embodiments, when the syntax element entropy_packet_enable is set to one (“1”), entropy packets for other syntax elements in the mesh code can be transmitted in entropy packets—e.g., such as a string of descriptors produced by Edgebreaker (e.g., CLERS symbols), per face properties, etc. In other embodiments, when the syntax element entropy_packet_enable is set to zero (‘0’), individualized entropy packets are not used. In such embodiments, different types of prediction errors (e.g., geometry, texture, material property, etc.), mesh connectivity information, and other basemesh syntax elements are packed together without an arithmetic coder being reset or terminated in between the different types of syntax elements. That is, the packets do not include an arithmetic coding start (e.g., ACS 810) or arithmetic coding end (e.g., ACE 820) between each different type of syntax element as described with reference to FIG. 8. Instead, the packets contain the ACS 810 and the ACE 820 at a start of the packet. In some embodiments, when the syntax element entropy_packet_enable is set to zero (“0”), there is no entropy packet header (e.g., EPH 805) inserted between each different syntax element either. Rather, there is a single entropy packet header at the start of the packet.

For example, FIG. 10 can illustrate an example prediction error transmission when the syntax element entropy_packet_enable is set to zero (“0”). In one embodiment, information 1000 includes all the prediction error information associated with a respective mesh. In at least some embodiments, the respective mesh may include additional information or less information—e.g., not each mesh has a “fine” geometry prediction error, a “coarse” geometry prediction error, a “fine” texture coordinate prediction error, a “coarse” texture coordinate prediction error, a “fine” material property prediction error, or a “coarse” material property prediction error. In at least one embodiment, the prediction error information 1000 is packed together without the arithmetic coding start (e.g., ACS 810) or arithmetic coding end (e.g., ACE 820). Additionally, the prediction error information 1000 can refrain from including an entropy packet header (e.g., EPH 805). Accordingly, prediction information 1000 can decode all of the prediction errors without resetting and terminating the arithmetic coding operations after each type of different prediction error. In at least one example, there may be an arithmetic coding start (e.g., ACS 810) and an entropy packet header (e.g., 805) prior to Ge-Fine 825 if a previous syntax element ended with an arithmetic coding end (e.g., ACE 820). In some examples, there may be the arithmetic coding end (e.g., ACE 820) after the ME2-Coarse 855 if a syntax element that follows it is in a different entropy packet.

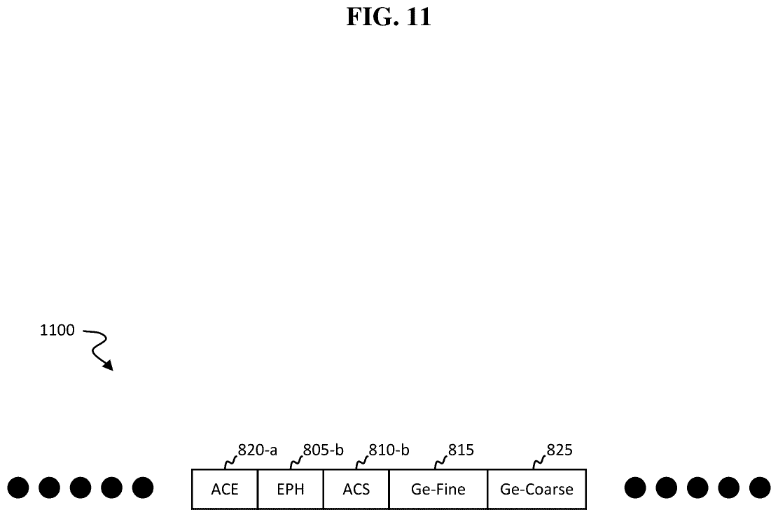

Referring back to FIG. 9, in some embodiments, the syntax field 910 can indicate a process if the entropy_packet_enable syntax is set to one (“1”)—e.g., in some embodiments, the syntax field 915 is conditioned on the syntax field 905. In at least one embodiment, the syntax element 915 geometry_entropy_packet_enable is set to one ‘1.’ In such embodiments, it indicates the start of a new entropy packet before a geometry prediction error sample as illustrated with reference to FIG. 11. For example, the information 1100 can include an arithmetic coding stop (ACE 820-a) indicating an end of a packet and an entropy packet header (EPH 805-b) and arithmetic coding start (ACS 810-b) to indicate the start of a new entropy packet. In such embodiments, the new entropy packet can include the prediction errors—e.g., include the geometry prediction errors associated with the fine and coarse categories (Ge-Fine 815 and Ge-Coarse 825).

In at least one embodiment, the syntax element 915 geometry_entropy_packet_enable is set to zero ‘0.’ In such embodiments, there is not a start of a new entropy packet before the geometry prediction errors. That is, information 1100 can include the prediction errors and be transmitted without having to include an arithmetic coding stop (ACE 820-a), the entropy packet header (EPH 805-b), or the arithmetic coding start (ACS 810-b). In such embodiments, the prediction errors are packed without indicating the start and end of the entropy packets.

In some embodiments, the geometry prediction error samples are packed into a same entropy packet. For example, the geometry prediction error samples of the “fine” category and the geometry prediction error samples of the “coarse” category can be packed into a same entropy packet. In such embodiments, the geometry prediction error samples of the “fine” category and the geometry prediction error samples of the “coarse” category can be interleaved. For example, the geometry prediction error samples can be transmitted in an order of a traversal of the mesh instead of transmitting all of the “fine” geometry prediction error samples first followed by transmitting all of the “coarse” geometry prediction error samples or vice versa.

Referring back to FIG. 9, in some embodiments, the syntax field 920 can indicate a packet packing process for material properties. That is, the material properties can have a corresponding number identifying the respective material property. In some embodiments, the material property can be assigned a value from zero (0) to a number of total material properties minus one (0 to num_material_properties−1). In such embodiments, syntax field 920 identifies a particular material property (e.g., a material property number i). In some embodiments, the syntax field 925 is conditioned on the syntax field 920—e.g., the syntax field 925 can be enabled or disabled when a material property is present or identified. In at least some embodiments, the material property is an example of a texture coordinate—e.g., the material property error sample is the texture coordinate error sample.

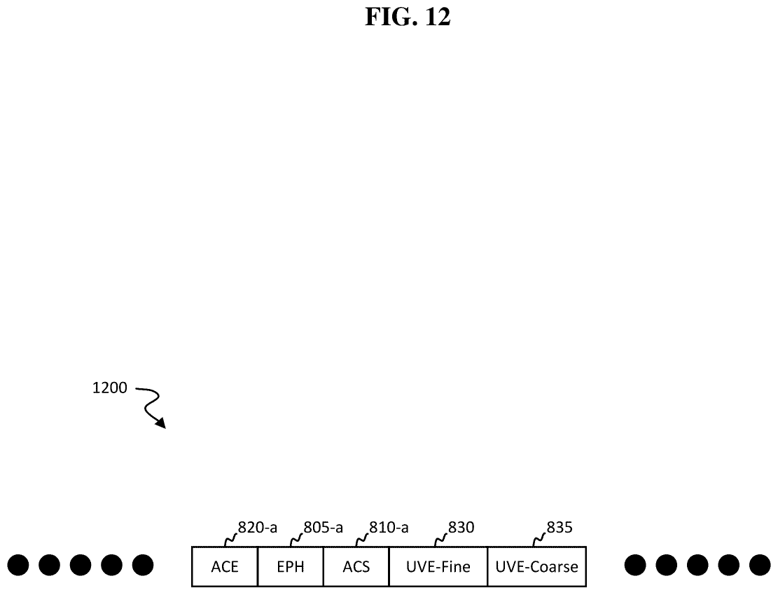

In at least one embodiment, the syntax element 925 material_properties_entropy_packet_enable[i] is set to one ‘1.’ In such embodiments, it indicates the start of a new entropy packet before a texture coordinate prediction error sample as illustrated with reference to FIG. 12. For example, information 1200 can include an arithmetic coding stop (ACE 820-a) indicating an end of a packet and an entropy packet header (EPH 805-b) and arithmetic coding start (ACS 810-b) to indicate the start of a new entropy packet. In such embodiments, the new entropy packet can include the prediction errors—e.g., include the texture coordinate prediction errors associated with the fine and coarse categories (UVE-Fine 830 and UVE-Coarse 835).

In some embodiments, the syntax element 925 material_properties_entropy_packet_enable[i] is set to zero ‘0.’ In such embodiments, there is not a start of a new entropy packet before the texture coordinate prediction errors. That is, information 1200 can include the prediction errors and be transmitted without having to include an arithmetic coding stop (ACE 820-a), the entropy packet header (EPH 805-b), or the arithmetic coding start (ACS 810-b). In such embodiments, the texture coordinate prediction errors are packed without indicating the start and end of the entropy packets.

In some embodiments, the texture coordinate prediction error samples are packed into a same entropy packet. For example, the texture coordinate prediction error samples of the “fine” category and the texture coordinate prediction error samples of the “coarse” category can be packed into a same entropy packet. In such embodiments, the texture coordinate prediction error samples of the “fine” category and the texture coordinate prediction error samples of the “coarse” category can be interleaved. For example, the texture coordinate prediction error samples can be transmitted in an order of a traversal of the mesh instead of transmitting all of the “fine” texture coordinate prediction error samples first followed by transmitting all of the “coarse” texture coordinate prediction error samples or vice versa.

In at least one embodiment, the syntax element 925 can also be enabled or disabled for material properties—e.g., for material property one (ME1) and material property two (ME2). In such embodiments, if the syntax element 925 material_properties_entropy_packet_enable[i] is set to one ‘1,’ it indicates the start of a new entropy packet before a material property prediction error for material property i. In such examples, the material property information can be packed into packets having a format similar to information 1100 or information 1200—e.g., the material property information can be packed into packets that can include an arithmetic coding stop (ACE 820-a) indicating an end of a packet and an entropy packet header (EPH 805-b) and arithmetic coding start (ACS 810-b) to indicate the start of a new entropy packet. In such embodiments, the new entropy packet can include the prediction errors—e.g., include the material property prediction errors associated with the fine and coarse categories for either the first or second material property—e.g., ME1-Fine 840, ME1-Coarse 845, ME2-Fine 850, or ME2-Coarse855.

In some embodiments, the syntax element 925 material_properties_entropy_packet_enable[i] is set to zero ‘0.’ In such embodiments, there is not a start of a new entropy packet before the material property prediction errors. That is, information 1200 can include the prediction errors and be transmitted without having to include an arithmetic coding stop (ACE 820-a), the entropy packet header (EPH 805-b), or the arithmetic coding start (ACS 810-b). In such embodiments, the material property prediction errors are packed without indicating the start and end of the entropy packets.

In at least one embodiment, the material property prediction error samples are packed into a same entropy packet. For example, the material property prediction error samples of the “fine” category and the material property prediction error samples of the “coarse” category can be packed into a same entropy packet. In such embodiments, the material property prediction error samples of the “fine” category and the material property prediction error samples of the “coarse” category can be interleaved. For example, the material property prediction error samples can be transmitted in an order of a traversal of the mesh instead of transmitting all of the “fine” material property prediction error samples first followed by transmitting all of the “coarse” material property prediction error samples or vice versa.

In at least one embodiment, one or more syntax elements are used to indicate a start of a new entropy packet for other types of information—e.g., information other than prediction error information. For example, one or more syntax elements can be used to indicate start of entropy packets including CLERS edge breaker indicators, per face properties, etc., in the mesh codec.

In at least one embodiment, the syntax elements 900 are transmitted in a sequence, mesh frame, sub-mesh, header, etc. That is, the basemesh encoder or decoder described with reference to FIGS. 4 and 5 can receive the syntax elements 900 and pack information according to the received syntax elements. In at least one embodiment, entropy packets are not used in a default state—e.g., the basemesh encoder or decoder can be initiated to not use entropy packets as a default. In such embodiments, the syntax elements 900 may not be signaled—e.g., they may not be transmitted since the basemesh encoder or decoder does not use entropy packets by default.

In at least one embodiment, different vertex prediction errors (e.g., geometry, texture coordinate, material property, etc.) and other syntax elements (e.g., CLERS coding, etc.) are interleaved on a per vertex basis instead of being grouped together. That is, transmitted information can include at least one of a “fine” geometry, texture coordinate, or material property prediction error, or a “coarse” geometry, texture coordinate, or material property prediction error for a vertex rather than transmitting all of the “fine” geometry information associated with all vertices first followed by all of the “coarse geometry information” and so forth.

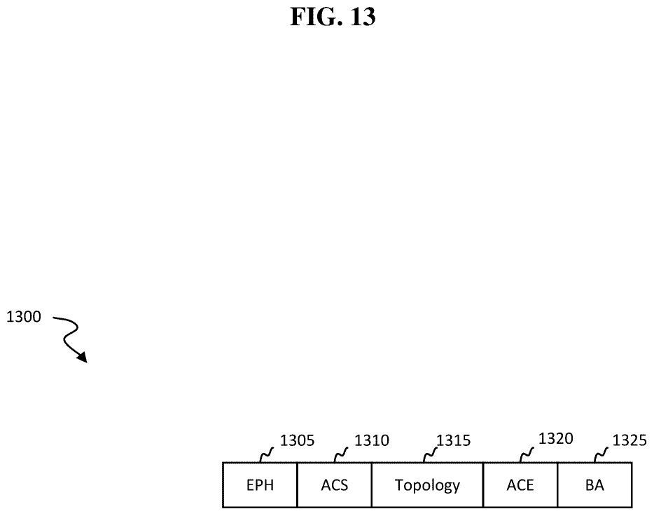

FIG. 13 illustrates an example entropy packet in video-based dynamic mesh coding (V-DMC). In at least one embodiment, packets 1300 have a format indicated in V-DMC TMM 7.0. The packets 1300 can be used to transmit one or more prediction errors (e.g., the prediction errors discussed with reference to FIGS. 6 and 7) or other topology information as described with reference to FIGS. 9-12 and herein. As described with reference to FIG. 8, a format of packets 1300 can enable entropy packets to be randomly accessed and individual packets can be decoded in parallel. However, including the arithmetic coding at the start (e.g., ACS 1310), the additional bits for terminating the arithmetic coding (e.g., ACE 1320), and the byte alignment (BA 1325) bits at the end of the packet can reduce the coding efficiency—e.g., the efficiency is reduced by starting and stopping the arithmetic operation for each individual packet. Accordingly, the efficiency of the system can be increased by disabling the entropy packets as described herein.

In one embodiment, packets 1300 can include an entropy packet header (EPH 1305) that includes an entropy packet length. In some examples, the packets 1300 can include an arithmetic coding start/initialization (ACS 1310) and an arithmetic coding stop/end (ACE 1320). In some embodiments, the packets 1300 can include byte alignment (BA) 1325 bits. In at least one embodiment, the packets 1300 can include topology 1315—e.g., syntax elements related to coding of topology or connectivity. In some embodiments, the topology 1315 can include information for fifteen (15) different syntax elements related to mesh handle, a mesh topology, a texture coordinate seam, a texture coordinate duplicate, an orientation for texture coordinates prediction, geometry prediction error (e.g., both fine and coarse), texture (UV) coordinate prediction error (e.g., both fine and coarse), face material proprieties (e.g., not predicted, right face, left face, facing, different, etc.).

In one embodiment, the following Table 1 can illustrate syntax elements for a packing prediction errors according to a basemesh codec. In some embodiments, portions of Table 1 are included in the CD of V-DMC, ISO/IEC SC29 WG07 N00885, June 2024:

TABLE 1

| Syntax Element | Descriptor |
|---|---|
| entropy_packet_enable | u(1) |
| if (entropy_packet_enable){ | |
| geometry_entropy_packet_enable | u(1) |
| for (i=0; i<mesh_attribute_count; i++ | |
| material_attribute_entropy_packet_enable[i] | u(1) |
| } | |
| ... | |
| if(geometry_entropy_packet_enable) | |
| mesh_coded_position_residuals_size | vu(v) |
| NumPredictedPositions=mesh_vertex_count- | |
| mesh_position_coarse_count | |
| for(j=0; j<3; j++{ | |
| for(i=0,i<NumPredictedPositions; i++){ | |
| mesh_position_residual[i][j] | ae(v) |
| } | |
| } | |
| } | |
| if(mesh_position_coarse_count>0){ | |
| NumPredictedCoarsePositions=mesh_position_coarse_count | |
| for(j=0; j<3; j++){ | |
| for(i=0; i<NumPredictedCoarsePositions; i++){ | |
| } | |
| } | |
| } | |
| if(geometry_entropy_packet_enable) | |
| padding_to_byte_alignemnt( ) | |

In at least one embodiment, during a binarization of a codeword including the prediction error, the following binarizations are used; u(n), u(v), ue(v), vi(v), vu(v), fl(n), ae(v). In one embodiment, the ae(v) indicates arithmetic-coded data (AC) and the remaining binarizations denote non-arithmetic coded data (non-AC). In some embodiments, the descriptors of Table 1 indicate which binarization a respective syntax element uses.

In some embodiments, two entropy packets are utilized to code geometry packet errors. In such embodiments, one entropy packet corresponds to a “fine” category geometry prediction error (e.g., mesh_coded_position_residuals_size) and another entropy packet corresponds to a “coarse” category geometry prediction error (e.g., mesh_coded_position_coarse_residuals_size). In one embodiment, the syntax mesh_coded_position_residuals_size also starts the entropy packet. In at least one embodiment, the entropy packet can include an arithmetic codec reset (e.g., evidenced by ad.start( ) below) and/or a padding_to_byte_alignment( ) to close the entropy packet. In at least one embodiment, the entropy packet can include an ad.stop( ) syntax to terminate the arithmetic coding operation before the padding_to_byte_alignment( ) In at least one embodiment, the syntax mesh_coded_position_coarse_residuals_size starts the entropy packet in addition to indicating the geometry prediction error in the “coarse” category. In some embodiments, the entropy packet indicated by mesh_coded_position_coarse_residuals_size can include an ad.start( ) to indicate an arithmetic operation start, a ad.stop( ) to indicate an arithmetic operation end, and/or an padding_to_byte_alignment( ) In some embodiments, the ad.start can follow the mesh_coded_position_coarse_residuals_size and the ad.stop( ) can proceed the padding_to_byte_alignment.

In at least one embodiment, the syntax element entropy_packet_enable of Table 1 can be a zero ‘0’ or a one ‘1.’ In one embodiment, when the syntax element is one ‘1’, it enables the use of different entropy packets for different types (e.g., categories) or syntax elements. For example, the syntax elements can include handle, topology, UV seam, UV duplicates, UV orientation, geometry prediction error (fine and coarse), UV coordinate prediction errors (fine and coarse), face identification (ID) (e.g., not predicted, right face, left face facing, different, etc.). That is, when the syntax element is one ‘1,’ each type of syntax element can be packed into their individual respective entropy packets. In other embodiments, when the syntax element entropy_packet_enable is zero ‘0,’ individual entropy packets are not used. That is, the syntax element information can be packed into one packet—e.g., a combined packet.

In some embodiments, the syntax element geometry_entropy_packet_enable of Table 1 can be a zero ‘0’ or a one ‘1.’ In one embodiment, when the syntax element geometry_entropy_packet_enable is one ‘1,’ it indicates a new entropy packet will start before the geometry prediction error samples. In other embodiments, when the syntax element geometry_entropy_packet_enable is zero ‘0,’ it indicates that there is no start of a new entropy packet before the geometry prediction error samples.

In some embodiments, semantics of mesh_coded_position_residual_size is modified to be in a size in bytes of both the fine and coarse category of the geometry prediction errors—e.g., a single packet can interleave the fine and coarse category geometry prediction errors as described with reference to FIG. 11. In at least one embodiment, the syntax element mesh_coded_position_residual_size is transmitted if the geometry_entropy_packet_enable is set to one ‘1’—e.g., the mesh_coded_position_residual_size is not transmitted if the geometry_entropy_packet_enable is set to zero ‘0.’ In at least one embodiment, a syntax element mesh_coded_position_coarse_residuals_size is deleted. That is, when the geometry_entropy_packet_enable is set to one ‘1,’ fine and coarse geometry prediction errors are packed into a same entropy packet.

In at least one embodiment, the padding_to_byte_alignment( ) and underlying arithmetic codec (e.g., ad.start and ad.stop) are conditional on geometry_entropy_packet_enable—e.g., when the geometry_entropy_packet_enable is set to zero ‘0,’ packets can be transmitted without the byte alignment (BA) bits and the arithmetic start and stop (e.g., ACE and ACS as described with reference to FIG. 8).

In at least one embodiment, syntax element material_attribute_entropy_packet_enable[i] is set to one ‘1’ to indicate that a new entropy packet will start before an i^{th} material attribute prediction error.

In at least one embodiment, the geometry_entropy_packet_enable can indicate (e.g., be expanded to indicate) to use a single entropy packet for all (or a subset) of geometry related syntax, including but not limited to:
mesh handle (e.g., mesh_handle_first_sign[i], mesh_handle_second_shift[i], mesh_handle_first_variable_delta_length4_minus1[i], mesh_handle_first_variable_delta[i], mesh_handle_second_variable_delta_length4_minus1[i], mesh_handle_second_variable_delta[i])
connectivity (e.g., mesh_clers_symbol[i])
geometry position fine residual (mesh_position_residual[i][j])
geometry position coarse residual (mesh_position_coarse_residual[i][j])
duplicate vertices flag (mesh_position_is_duplicate_flag[i])

In at least one embodiment, the material_attribute_entropy_packet_enable[i] can indicate (e.g., be expanded to indicate) to use a single entropy packet for all (or a subset) of material attribute related syntax, including but not limited to:
material attribute seam (mesh_attribute_seam[i][j])
material attribute fine prediction error (mesh_attribute_residual[i][j][k])
material attribute coarse prediction error (mesh_attribute_coarse_residual[i][j][k])
orientation for texture coordinate stretch prediction (mesh_texcoord_stretch_orientation[index][j])
mesh material identification information (mesh_materialid_default_not_equal_flag[index][j], mesh_materialid_default_left_flag[index][j], mesh_materialid_default_right_flag[index][j], mesh_materialid_default_facing_flag[index][j]
mesh attribute duplicate information (mesh_attribute_is_duplicate_flag[index][i])

In at least one embodiment, a flag is signaled in a mesh coding header to indicate the use of entropy packets. For example, a flag mesh_entropy_packet_flag is included in the mesh coding header. In one embodiment, when the flag has a value zero ‘0’ (e.g., mesh_entropy_packet_flag is zero ‘0’), a single entropy packet is used. In other embodiments, when the flag has a value one ‘1’ (e.g., the mesh_entropy_packet_flag is one ‘1’), an N number of entropy packets is used. In at least one embodiment, N is a predetermined number. In one embodiment, the value of N is four (4). In other embodiments, N is a positive integer greater than or equal to one (1)—e.g., N is 1, 2, 3, 4, etc. In one embodiment, Table 2 can illustrate a mesh coding header:

TABLE 2

| | Descriptor |
|---|---|
| mesh_coding_header( ){ | |
| mesh_codec_type | u(2) |
| mesh_vertex_traversal_method | u(2) |
| mesh_position_encoding_parameters( ) | |
| mesh_position_dequantize_flag | u(1) |
| if(mesh_position_dequantize_flag) | |
| mesh_position_dequantize_parameters | |
| mesh_entropy_packet_flag | u(1) |
| mesh_attribute_count | u(5) |

In at least one embodiment, at a start of each entropy packet, an arithmetic coder is reset. In some embodiments, at an end of each entropy packet, the arithmetic coder is terminated and byte aligned.

In at least one embodiment, when the mesh_entropy_packet_flag has a value one ‘1,’ the following entropy packets are used: mesh_entropy_packet_geometry( ) mesh_entropy_packet_texcoord( ) mesh_entropy_packet_normals( ) and mesh_entropy_packet_materialid( ) In at least one embodiment, the four entropy packets correspond to a geometry prediction error, a texture coordinate prediction error, a normal prediction error, and a material property prediction error, respectively. In some embodiments, the following syntax can denote a corresponding byte size for each of the four entropy packets: mesh_entropy_packet_geometry_size, mesh_entropy_packet_texcoord_size, mesh_entropy_packet_normals_size, mesh_entropy_packet_materialid_size. In at least one embodiment, syntax elements transmitted in the geometry entropy packet (e.g., mesh_entropy_packet_geometry( )) are given in mesh_entropy_packet_geometry_syntax_elements( ) In at least one embodiment, syntax elements transmitted in the texture coordinate entropy packet (e.g., mesh_entropy_packet_texcoord( )) are given in mesh_entropy_packet_texcoord_syntax_elements( ) In at least one embodiment, syntax elements transmitted in the normal entropy packet (e.g., mesh_entropy_packet_normals( )) are given in mesh_entropy_packet_normals_syntax_elements( ) In at least one embodiment, syntax elements transmitted in the material property entropy packet (e.g., mesh_entropy_packet_materialids( ) are given in mesh_entropy_packet_materialids_syntax_elements( ).

In some embodiments, when the mesh_entropy_packet_flag has a value zero ‘0,’ a single entropy packet is used. In such embodiments, the single entropy packet can be denoted mesh_entropy_packet_all( ) In at least one embodiment, a syntax mesh_entropy_packet_size indicates a corresponding entropy packet size in bytes. In at least one embodiment, syntax elements transmitted in the single entropy packet (e.g., mesh_entropy_packet_all_size) are given in the syntax elements for each respective type of entropy packet—e.g., in mesh_entropy_packet_geometry_syntax_elements( ), mesh_entropy_packet_texcoord_syntax_elements( ), mesh_entropy_packet_normals_syntax_elements( ), and mesh_entropy_packet_materialids_syntax_elements( ).

In some embodiments, a syntax for packing a prediction error can take a format of Table 3. In some embodiments, Table 3 can indicate the entropy packet flag and the syntax elements for each of the different entropy packet types (e.g., for each of the prediction error types) as follows:

TABLE 3

| | Descriptor |
|---|---|
| if(mesh_entropy_packet_flag) | |
| mesh_entropy_packet_geometry_size | vu(v) |
| mesh_entropy_packet_geometry( ) | |
| mesh_entropy_packet_texcooord_size | vu(v) |
| mesh_entropy_packet_texcoord( ) | |
| mesh_entropy_packet_normals_size | vu(v) |
| mesh_entropy_packet_normals( ) | |
| mesh_entropy_packet_materialid_size | vu(v) |
| mesh_entropy_packet_materialid( ) | |
| else | |
| mesh_entropy_packet_all_size | |
| mesh_entropy_packet_all | vu(v) |
| mesh_entropy_packet_geometry( ) | |
| mesh_entropy_packet_geometry_syntax_elements( ) | |
| mesh_entropy_packet_texcoord( ) | |
| mesh_entropy_packet_texcoord_syntax_elements( ) | |
| mesh_entropy_packet_normals( ) | |
| mesh_entropy_packet_normals_syntax_elements( ) | |
| mesh_entropy_packet_materialid( ) | |
| mesh_entropy_packet_materialid_syntax_elements( ) | |
| mesh_entropy_packet_all( ) | |
| mesh_entropy_packet_geometry_syntax_elements( ) | |
| mesh_entropy_packet_texcoord_syntax_elements( ) | |
| mesh_entropy_packet_normals_syntax_elements( ) | |
| mesh_entropy_packet_materialid_syntax_elements( ) | |
| mesh_entropy_packet_geometry_syntax_elements ( ) | |
| for( i=0; i< mesh_handles_count; i++ ){ | |
| mesh_handle_first_sign[ i ] | ae(v) |
| mesh_handle_second_shift[ i ] | ae(v) |
| mesh_handle_first_variable_delta_length4_minus1[ i ] | ae(v) |
| mesh_handle_first_variable_delta[ i ] | ae(v) |
| mesh_handle_second_variable_delta_length4_minus1[ i ] | ae(v) |
| mesh_handle_second_variable_delta[ i ] | ae(v) |
| } | |
| for( i=0; i <mesh_clers_count; i++ ) { | |
| mesh_clers_symbol[ i ] | ae(v) |
| } | |
| for( i = 0; i< NumPositionIsDuplicateFlags; i++ ) { | |
| mesh_position_is_duplicate_flag[ i ] | ae(v) |
| } | |
| for( j = 0; j < 3; j++ ){ | |
| for( i = 0; i < NumPredictedFinePositions; i++ ) { | |
| mesh_position_fine_residual[ i ][ j ] | ae(v) |
| } | |
| } | |
| for( j = 0; j < 3; j++ ){ | |
| for( i = 0; i < NumPredictedCoarsePositions; i++ ) { | |
| mesh_position_coarse_residual[ i ][ j ] | ae(v) |
| } | |
| } | |
| mesh_entropy_packet_texcoord_syntax_elements() | Descriptor |
| for( j = 0; j < mesh_attribute_seams_count[ i ]; j++ ) { | |
| mesh_attribute_seam[ i ][ j ] | ae(v) |
| } | |
| for( i = 0; i < NumAttributeIsDuplicateFlags[ index ]; i++ ) { | |
| mesh_attribute_is_duplicate_flag[ index ][ i ] | ae(v) |
| } | |
| for( j = 0; j < mesh_texcoord_stretch_orientations_count[ index ]; j++ ) { | |
| mesh_texcoord_stretch_orientation[ index ][ j ] | ae(v) |
| } | |
| for( j = 0; j < mesh_attribute_fine_residuals_count[ i ]; j++ ) { | |
| for( k = 0; k < NumComponents[ i ]; k++ ) { | |
| mesh_attribute_fine_residual[ i ][ j ][ k ] | ae(v) |
| } | |
| } | |
| for( j = 0; j < mesh_attribute_coarse_residuals_count[ i ]; j++ ) { | |
| for( k = 0; k < NumComponents[ i ]; k++ ) { | |
| mesh_attribute_coarse_residual[ i ][ j ][ k ] | ae(v) |
| } | |
| } | |
| mesh_entropy_packet_normals_syntax_elements( ) | Descriptor |
| for( j = 0; j < mesh_attribute_seams_count[ i ]; j++ ) { | |
| mesh_attribute_seam[ i ][ j ] | ae(v) |
| } | |
| for( i = 0; i < NumAttributeIsDuplicateFlags[ index ]; i++ ) { | |
| mesh_attribute_is_duplicate_flag[ index ][ i ] | ae(v) |
| } | |
| for( j = 0; j < mesh_attribute_fine_residuals_count[ i ]; j++ ) { | |
| for( k = 0; k < NumComponents[ i ]; k++ ) { | |
| mesh_attribute_fine_residual[ i ][ j ][ k ] | ae(v) |
| } | |
| } | |
| for( j = 0; j < mesh_attribute_coarse_residuals_count[ i ]; j++ ) { | |
| for( k = 0; k < NumComponents[ i ]; k++ ) { | |
| mesh_attribute_coarse_residual[ i ][ j ][ k ] | ae(v) |
| } | |
| } | |
| for( j = 0; j < mesh_normal_octrahedral_second_residuals_count[ index ]; j++ ) { | |
| for( k = 0; k < 3; k++ ) { | |
| mesh_normal_octahedral_second_residual[ index ][ j ][ k ] | ae(v) |
| } | |
| } | |
| mesh_entropy_packet_materialid_syntax_elements( ) | Descriptor |
| for( j = 0; j < mesh_materialid_default_not_equal_count[ index ]; j++ ){ | |
| mesh_materialid_default_not_equal_flag[ index ][ j ] | ae(v) |
| } | |
| for( j = 0; j < mesh_materialid_default_left_count[ index ]; j++ ) { | |
| mesh_materialid_default_left_flag[ index ][ j ] | ae(v) |
| } | |
| for( j = 0; j < mesh_materialid_default_right_count[ index ]; j++ ) { | |
| mesh_materialid_default_right_flag[ index ][ j ] | ae(v) |
| } | |
| for( j = 0; j < mesh_materialid_default_facing_count[ index ]; j++ ) { | |
| mesh_materialid_default_facing_flag[ index ][ j ] | ae(v) |
| } | |

In at least one embodiment, a syntax element mesh_entropy_packet is signaled in a mesh coding header. In some embodiments, the syntax element mesh_entropy_packet can have any value, where each value of any value corresponds to a different number of entropy packets.

In at least one embodiment, packing prediction errors can follow the following syntax and semantics (e.g., starting from paragraph and ending on paragraph [0212]). In some embodiments, the following syntax and semantics (e.g., at least a portion of the following syntax and semantics) can be found as section I.8 in CD of V-DMC, ISO/IEC SC29 WG07 N00885, June 2024. It should be noted the following semantics and syntax are a possible naming convention for the semantics and syntax. The semantics and syntax can take on a different name or identity—e.g., the following semantics and syntax can be called or referred to as something else. In at least one embodiment, the following semantics and syntax also include a mechanism for a buffer pointer (e.g., bufferPtr). In such embodiments, the buffer pointer specifies that the respective syntax element is parsed from a buffer location indicated by the buffer pointer. In at least one embodiment, the buffer pointer is advanced to a next position beyond the syntax element in a bitstream parsing process.

### *Start of Syntax and Semantics

### I.8 Syntax and Semantics

### I.8.1 Method of Specifying Syntax in Tabular Form

The specifications in subclause 8.1 apply with the following additions. The following table lists an additional example of the syntax specification form. When syntax_element, bufferPtr appears, it specifies that a syntax element is parsed from the buffer location pointed to by bufferPtr. The pointer, bufferPtr, is advanced to the next position beyond the syntax element in the bitstream parsing process.

| | Descriptor |
|---|---|
| syntax_element, bufferPtr | ae(v) |

### I.8.2 Specification of Syntax Functions and Descriptors

The specifications in subclause 8.2 apply with the following additions. read_byte(n) reads the next n bytes from the bitstream and advances the bitstream pointer by (n*8) bit positions. It also returns a pointer to a buffer of size n bytes containing the n byte that were read from the bitstream. It is a requirement of bitstream conformance that n is greater than 0. The following descriptors specify additional syntax element parsing processes:
ae(v): context-adaptive arithmetic entropy-coded syntax element. The parsing process for this descriptor is specified in clause I. 10.3
vu(v): unsigned integer using a variable number of bytes as groups of 8 bits. The parsing process for this descriptor is specified by the return values of the functions read_bits(1) followed by read_bits(7). The second value is appended to the resulting bit sequence and the process iterated while the first value is equal to 1. In particular, the parsing process for this descriptor is specified as follows:

◯ vu(v) {

▪ value=0
▪ do (

● continue=read_bits(1)
● partial_value=read_bits(7)
● value= (value<<7) |partial_value

▪ }
▪ while (continue)
▪ return value

◯ }

vi(v): signed integer using a variable number of bytes as groups of 8 bits. The parsing process for this descriptor is specified by the return values of the functions read_bits(1) followed by read_bits(7). The second value is appended to the resulting bit sequence and the process iterated while the first value is equal to 1. The resulting bit sequence interpreted as an unsigned integer is assigned to a signed integer value considering that syntax elements have been mapped to unsigned integers by ordering those by their absolute value in increasing order and representing the positive value for a given absolute value with the highest coded value. Table I-1 provides the assignment rule. In particular, the parsing process for this descriptor is specified as follows:

◯ vi(v) {

▪ value = 0
▪ do {

● continue= read_bits(1)
● partial_value=read_bits(7)
● value=(value<<7) |partial_value

▪ }
▪ while(continue)
▪ is_positive= ! (value & 1)
▪ value = (value>>1)
▪ if(is_positive)

● return value

▪ else

● return − (value + 1)

◯ }

TABLE I-1
Assignment of syntax element to codeNum

| codeNum | syntax element value |
|---|---|
| 0 | 0 |
| 1 | −1 |
| 2 | 1 |
| 3 | −2 |
| 4 | 2 |
| 5 | −3 |
| 6 | 3 |
| k | $( \frac{k + 1}{2} ) * {( - 1 )}^{k}$ |

### I.8.3 Syntax in Tabular Form

### I.8.3.1 General Mesh Coding Syntax

Descriptor

```
mesh_coding( ) {
  mesh_coding_header( )
  mesh_position_coding_payload( )
  mesh_attribute_coding_payload( )
}
```

### I.8.3.2 Mesh Coding Header Syntax

| | Descriptor |
|---|---|
| mesh_coding_header( ) { | |
| mesh_codec_type | u(2) |
| mesh_vertex_traversal_method | u(2) |
| mesh_position_encoding_parameters( ) | |
| mesh_position_dequantize_flag | u(1) |
| if( mesh_position_dequantize_flag ) | |
| mesh_position_dequantize_parameters( ) | |
| mesh_entropy_packets_enable_flag | u(1) |
| mesh_attribute_count | u(5) |
| for( i = 0; i < mesh_attribute_count; i++ ) { | |
| mesh_attribute_type[ i ] | u(3) |
| if( mesh_attribute_type[ i ] == MESH_ATTR_TEXCOORD ) | |
| NumComponents[ i ] = 2 | |
| else if( mesh_attribute_type[ i ] == MESH_ATTR_NORMAL ) { | |
| NumComponents[ i ] = 3 | |
| mesh_normal_octahedral_flag[ i ] | u(1) |
| } | |
| else if( mesh_attribute_type[ i ] == MESH_ATTR_COLOR ) | |
| NumComponents[ i ] = 3 | |
| else if( mesh_attribute_type[ i ] == MESH_ATTR_MATERIAL_ID ) | |
| NumComponents[ i ] = 1 | |
| else if( mesh_attribute_type[ i ] == MESH_ATTR_GENERIC ) { | |
| mesh_attribute_num_components_minus1[ i ] | u(2) |
| NumComponents[ i ] = mesh_attribute_num_components_minus1[ i ] + 1 | |
| } | |
| if( mesh_normal_octahedral_flag[ i ] ) | |
| NumResidualsComponents[ i ] = 2 | |
| else | |
| NumResidualsComponents[ i ] = NumComponents[ i ] | |
| mesh_attribute_encoding_parameters ( i ) | |
| mesh_attribute_dequantize_flag[ i ] | u(1) |
| if( mesh_attribute_dequantize_flag[ i ] ) | |
| mesh_attribute_dequantize_parameters( i ) | |
| } | |
| mesh_deduplicate_method | ue(v) |
| padding_to_byte_alignment( ) | |
| } | |

### I.8.3.3 Mesh Position Encoding Parameters Syntax

| | Descriptor |
|---|---|
| mesh_position_encoding_parameters( ){ | |
| mesh_position_bit_depth_minus1 | u(5) |
| mesh_position_prediction_method | ue(v) |
| mesh_position_reverse_unification_flag | u(1) |
| } | |

### I.8.3.4 Mesh Position Dequantize Parameters Syntax

| | Descriptor |
|---|---|
| mesh_position_dequantize_parameters( ) { | |
| for( i = 0; i < 3; i++ ) { | |
| mesh_position_min[ i ] | fl(32) |
| mesh_position_max[ i ] | fl(32) |
| } | |
| } | |

### I.8.3.5 Mesh Attributes Encoding Parameters Syntax

| | Descriptor |
|---|---|
| mesh_attribute_encoding_parameters( index ) { | |
| mesh_attribute_bit_depth_minus1[ index ] | u(5) |
| mesh_attribute_per_face_flag[ index ] | u(1) |
| if( !mesh_attribute_per_face_flag[ index ] ) { | |
| mesh_attribute_separate_index_flag[ index ] | u(1) |
| if( !mesh_attribute_separate_index_flag[ index ] ) | |
| mesh_attribute_reference_index_plus1[ index ] | ue(v) |
| } | |
| mesh_attribute_prediction_method[ index ] | ue(v) |
| } | |

### I.8.3.6 Mesh Attributes Dequantize Parameters Syntax

| | Descriptor |
|---|---|
| mesh_attribute_dequantize_parameters( index ) { | |
| for( j = 0; j < NumComponents[ index ]; j++ ) { | |
| mesh_attribute_min[ index ][ j ] | fl(32) |
| mesh_attribute_max[ index ][ j ] | fl(32) |
| } | |
| } | |

### I.8.3.7 Mesh Position Coding Payload Syntax

| | Descriptor |
|---|---|
| mesh_position_coding_payload( ) { | |
| mesh_triangle_count | vu(v) |
| mesh_position_start_count | vu(v) |
| mesh_position_fine_residuals_count | vu(v) |
| mesh_position_coarse_residuals_count | vu(v) |
| mesh_clers_count | vu(v) |
| mesh_cc_with_boundary_count | vu(v) |
| mesh_handles_count | vu(v) |
| MinHandles = 10 | |
| if( mesh_handles_count < MinHandles ) { | |
| for( i=0; i < mesh_handles_count; i++ ){ | |
| mesh_handle_first_delta[ i ] | vi(v) |
| mesh_handle_second_delta[ i ] | vi(v) |
| } | |
| padding_to_byte_alignment( ) | |
| } | |
| if( mesh_entropy_packets_enable_flag ) { | |
| mesh_position_packet_size | vu(v) |
| EntropyPacketPtr = read_bytes(mesh_position_packet_size) | |
| } else { | |
| mesh_all_packet_size | vu(v) |
| EntropyPacketPtr = read_bytes(mesh_all_packet_size) | |
| } | |
| if ( mesh_handles_count >= MinHandles ) { | |
| for( i=0; i< mesh_handles_count; i++ ){ | |
| mesh_handle_first_sign[ i ], EntropyPacketPtr | ae(v) |
| mesh_handle_second_shift[ i ], EntropyPacketPtr | ae(v) |
| mesh_handle_first_variable_delta_length4_minus1[ i ], | ae(v) |
| EntropyPacketPtr | |
| mesh_handle_first_variable_delta[ i ], EntropyPacketPtr | ae(v) |
| mesh_handle_second_variable_delta_length4_minus1[ i ], | ae(v) |
| EntropyPacketPtr | |
| mesh_handle_second_variable_delta[ i ], | ae(v) |
| EntropyPacketPtr | |
| } | |
| } | |
| for( i=0; i <mesh_clers_count; i++ ) { | |
| mesh_clers_symbol[ i ], EntropyPacketPtr | ae(v) |
| } | |
| NumPositionStart = mesh_position_start_count | |
| for( i=0; i < NumPositionStart; i++ ) { | |
| for( j = 0; j < 3; j++ ) { | |
| mesh_position_start[ i ][ j ] | u(v) |
| } | |
| } | |
| padding_to_byte_alignment( ) | |
| NumPredictedFinePositions = mesh_position_fine_residuals_count | |
| if( mesh_position_fine_residuals_count > 0 ) { | |
| for( j = 0; j < 3; j++ ){ | |
| for( i = 0; i < NumPredictedFinePositions; i++ ) { | |
| mesh_position_fine_residual[ i ][ j ], | ae(v) |
| EntropyPacketPtr | |
| } | |
| } | |
| } | |
| NumPredictedCoarsePositions = mesh_position_coarse_residuals_count | |
| if( mesh_position_coarse_residuals_count > 0 ) { | |
| for( j = 0; j < 3; j++ ){ | |
| for( i = 0; i < NumPredictedCoarsePositions; i++ ) { | |
| mesh_position_coarse_residual[ i ][ j ], | ae(v) |
| EntropyPacketPtr | |
| } | |
| } | |
| } | |
| mesh_position_deduplicate_information( ) | |
| if( mesh_position_reverse_unification_flag ) { | |
| mesh_difference_information( ) | |
| } | |
| } | |

### I.8.3.8 Mesh Position Deduplicate Information Syntax

| | Descriptor |
|---|---|
| mesh_position_deduplicate_information( ) { | |
| if( mesh_deduplicate_method == MESH_{——}DEDUP_DEFAULT ) { | |
| mesh_position_deduplicate_count | vu(v) |
| if( mesh_position_deduplicate_count > 0 ){ | |
| NumSplitVertex = 0 | |
| for( i=0; i < mesh_position_deduplicate_count; i++ ) { | |
| mesh_position_deduplicate_idx[ i ] | vu(v) |
| NumSplitVertex = Max( NumSplitVertex, | |
| mesh_position_deduplicate_idx[ i ] + 1 ) | |
| } | |
| NumAddedDuplicatedVertex = mesh_position_deduplicate_count | |
| − NumSplitVertex | |
| NumPositionIsDuplicateFlags = NumPositionStart | |
| + NumPredictedFinePositions | |
| + NumPredictedCoarsePositions | |
| + NumAddedDuplicatedVertex | |
| for( i = 0; i< NumPositionIsDuplicateFlags; i++ ) { | |
| mesh_position_is_duplicate_flag[ i ], | ae(v) |
| EntropyPacketPtr | |
| } | |
| } | |
| } | |
| } | |

### I.8.3.9 Mesh Difference Information Syntax

| | Descriptor |
|---|---|
| mesh_difference_information( ) { | |
| mesh_position_added_vertices_count | vu(v) |
| if( mesh_position_added_vertices_count > 0 ) { | |
| for( i = 0; i < mesh_position_added_vertices_count; i++ ) { | |
| mesh_position_added_vertices_idx_delta[ i ] | vi(v) |
| } | |
| } | |
| padding_to_byte_alignment( ) | |
| mesh_position_deleted_vertices_count | vu(v) |
| if( mesh_position_deleted_vertices_count >0 ) { | |
| for( i = 0; i < mesh_position_deleted_vertices_count; i++ ) { | |
| mesh_position_deleted_vertices_idx_delta[ i ] | vi(v) |
| } | |
| } | |
| padding_to_byte_alignment( ) | |
| mesh_modified_count | vu(v) |
| if( mesh_modified_count >0 ) { | |
| for( i = 0; i < mesh_modified_count; i++ ) { | |
| mesh_modified_triangles_idx_delta[ i ] | vi(v) |
| } | |
| for( i = 0; i < mesh_modified_count; i++ ) { | |
| mesh_modified_vertices_relative_idx[ i ] | vu(v) |
| } | |
| for( i = 0; i < mesh_modified_count; i++ ) { | |
| mesh_target_modified_vertices_idx_delta[ i ] | vi(v) |
| } | |
| padding_to_byte_alignment( ) | |
| } | |
| } | |

### I.8.3.10 Mesh Attribute Coding Payload Syntax

| | Descriptor |
|---|---|
| mesh_attribute_coding_payload( ) { | |
| for( i = 0; i < mesh_attribute_count; i++ ) { | |
| mesh_attribute_start_count[ i ] | vu(v) |
| mesh_attribute_fine_residuals_count[ i ] | vu(v) |
| mesh_attribute_coarse_residuals_count[ i ] | vu(v) |
| AttributeType = mesh_attribute_type[ i ] | |
| AttributePredictionMethod = mesh_attribute_prediction_method[ i ] | |
| AttrPacketPtr = EntropyPacketPtr | |
| if( mesh_entropy_packets_enable_flag ) { | |
| if( AttributeType == MESH_ATTR_TEXCOORD ) { | |
| mesh_uv_packet_size | vu(v) |
| AttrPacketPtr = read_bytes( mesh_uv_packet_size ) | |
| } else if( AttributeType == MESH_ATTR_NORMAL ) { | |
| mesh_normal_packet_size | vu(v) |
| AttrPacketPtr = read_bytes( mesh_normal_packet_si | |
| ze ) | |
| }elseif (AttributeType == MESH_ATTR_MATERIAL_ID ){ | |
| mesh_material_id_packet_size | vu(v) |
| AttrPacketPtr = read_bytes( mesh_material_id_packe | |
| t_size ) | |
| } | |
| } | |
| if( mesh_attribute_separate_index_flag[ i ]) { | |
| mesh_attribute_seams_count[ i ] | vu(v) |
| if( mesh_attribute_seams_count > 0 ) { | |
| for( j = 0; j < mesh_attribute_seams_count[ i ]; j++ ) { | |
| mesh_attribute_seam[ i ][ j ], AttrPacketPtr | ae(v) |
| } | |
| } | |
| } | |
| NumAttributeStart[ i ] = mesh_attribute_start_count[ i ] | |
| for( j = 0; j < mesh_attribute_start_count[ i ]; j++ ) { | |
| for( k = 0; k< NumComponents[ i ]; k++ ) { | |
| mesh_attribute_start[ i ][ j ][ k ] | u(v) |
| } | |
| } | |
| padding_to_byte_alignment( ) | |
| if( mesh_attribute_fine_residuals_count[ i ] ){ | |
| for( j = 0; j < mesh_attribute_fine_residuals_count[ i ]; j++ ) { | |
| for( k = 0; k < NumResidualsComponents[ i ]; k++ ) { | |
| mesh_attribute_fine_residual[ i ][ j ][ k ], | ae(v) |
| AttrPacketPtr | |
| } | |
| } | |
| } | |
| if( mesh_attribute_coarse_residuals_count[ i ] > 0 ){ | |
| if( mesh_coded_attribute_coarse_redisuals_size[ i ] > 0 ) { | |
| for( j = 0; j < mesh_attribute_coarse_residuals_count[ i ]; | |
| j++ ) { | |
| for( k = 0; k < NumResidualsComponents[ i ]; k++ ) { | |
| mesh_attribute_coarse_residual[ i ][ j ][ k ], | ae(v) |
| AttrPacketPtr | |
| } | |
| } | |
| } | |
| } | |
| if(mesh_attribute_separate_index_flag[ i ]) | |
| mesh_attribute_deduplicate_info( i ) | |
| /*extra data dependent on the selected prediction scheme*/ | |
| mesh_attribute_extra_data( i, AttributeType, AttributePredictionMet | |
| hod ) | |
| } | |
| padding_to_byte_alignment( ) | |
| } | |

### I.8.3.11 Mesh Extra Attribute Data Syntax

Descriptor

```
mesh_attribute_extra_data( index, type, method ) {
  if( type == MESH_ATTR_TEXCOORD ) {
  if( method == MESH_TEXCOORD_MSTRETCH )
      mesh_texcoord_stretch_extra_data( index )
  }
  else if( type == MESH_ATTR_NORMAL )
      if( mesh_normal_octahedral_flag[ index ] ) {
      mesh_normal_octahedral_extra_data( index )
      }
  else if( type == MESH_ATTR_COLOR )
      /* No extra data defined for specified prediction
methods applied on colors */
  else if( type == MESH_ATTR_MATERIAL_ID ) {
    if( method == MESH_MATERIALID_DEFAULT )
      mesh_materialid_default_extra_data( index )
  }
  else if( type == MESH_ATTR_GENERIC )
      /* No extra data defined for specified prediction
methods applied on generic*/
}
```

### I.8.3.12 Mesh Texcoord Stretch Extra Data Syntax

| | Descriptor |
|---|---|
| mesh_texcoord_stretch_extra_data( index ) { | |
| mesh_texcoord_stretch_orientations_count[ index ] | vu(v) |
| if(mesh_texcoord_stretch_orientations_count[ index ] > 0 ) { | |
| for( j = 0; j < mesh_texcoord_stretch_orientations_count[ index ]; | |
| ++ ) { | |
| mesh_texcoord_stretch_orientation[ index ][ j ], | ae(v) |
| AttrPacketPtr | |
| } | |
| } | |
| } | |

### I.8.3.13 Mesh Materialid Default Extra Data Syntax

| | Descriptor |
|---|---|
| mesh_materialid_default_extra_data( index ) { | |
| mesh_materialid_default_not_equal_count[ index ] | vu(v) |
| mesh_materialid_default_left_count[ index ] | vu(v) |
| mesh_materialid_default_right_count[ index ] | vu(v) |
| mesh_materialid_default_facing_count[ index ] | vu(v) |
| if( mesh_materialid_default_not_equal_count[ index ] > 0 ){ | |
| for( j = 0; j < mesh_materialid_default_not_equal_count[ index ]; j | |
| ++ ){ | |
| mesh_materialid_default_not_equal_flag[ index ][ j ], | ae(v) |
| AttrPacketPtr | |
| } | |
| } | |
| if( mesh_materialid_default_left_count[ index ] > 0 ){ | |
| for( j = 0; j < mesh_materialid_default_left_count[ index ]; j++ ) { | |
| mesh_materialid_default_left_flag[ index ][ j ], | ae(v) |
| AttrPacketPtr | |
| } | |
| } | |
| if( mesh_materialid_default_right_count[ index ] > 0 ) { | |
| for( j = 0; j < mesh_materialid_default_right_count[ index ]; j++ ) { | |
| mesh_materialid_default_right_flag[ index ][ j ], | ae(v) |
| AttrPacketPtr | |
| } | |
| } | |
| if( mesh_materialid_default_facing_count[ index ] > 0 ){ | |
| for( j = 0; j < mesh_materialid_default_facing_count[ index ]; j++ ) | |
| { | |
| mesh_materialid_default_facing_flag[ index ][ j ], | ae(v) |
| AttrPacketPtr | |
| } | |
| } | |
| } | |

### I.8.3.14 Mesh Normal Octahedral Extra Data Syntax

| | Descriptor |
|---|---|
| mesh_normal_octahedral_extra_data( index ) { | |
| mesh_normal_octahedral_bit_depth_minus1[ index ] | u(5) |
| mesh_normal_octahedral_second_residual_flag[ index ] | u(1) |
| padding_to_byte_alignment( ) | |
| if( mesh_normal_octahedral_second_residuals_flag[ index ] ){ | |
| mesh_normal_octahedral_second_residuals_count[ index ] | vu(v) |
| if ( mesh_normal_octrahedral_second_residuals_count[ index ] ) { | |
| for( j = 0; j < mesh_normal_octrahedral_second_residuals_count[ inde | |
| x ]; j++ ) { | |
| for( k = 0; k < 3; k++ ) { | |
| mesh_normal_octahedral_second_residual[ index ][ j ][ k ], | ae(v) |
| AttrPacketPtr | |
| } | |
| } | |
| } | |
| } | |
| } | |

### I.8.3.15 Mesh Attribute Deduplicate Information Syntax

| | Descriptor |
|---|---|
| mesh_attribute_deduplicate_info( index ) { | |
| if( mesh_deduplicate_method == MESH_{——}DEDUP_DEFAULT ) { | |
| mesh_attribute_deduplicate_count[ index ] | vu(v) |
| if( mesh_position_deduplicate_count[ index ] > 0 ){ | |
| NumSplitAttribute[ index ] = 0 | |
| for( i = 0; i < mesh_attribute_deduplicate_count[ index ]; i | |
| ++ ) { | |
| mesh_attribute_deduplicate_idx[ index ][ i ] | vu(v) |
| NumSplitAttribute[ index ] = Max(NumSplitAttribute[ index ], | |
| mesh_attribute_deduplicate_idx[ index ][ i ] + 1) | |
| } | |
| NumAddedDuplicatedAttribute[ index ] = | |
| mesh_attribute_deduplicate_count[ index ] − NumSplitAttribute[ inde | |
| x ] | |
| NumAttributeIsDuplicateFlags[ index ] = NumAttributeStart[ index ] | |
| +mesh_attribute_fine_residuals_count[ index ] | |
| +mesh_attribute_coarse_residuals_count[ index | |
| +NumAddedDuplicatedAttribute[ index ] | |
| for( i = 0; i < NumAttributeIsDuplicateFlags[ index ]; i++ ) { | |
| mesh_attribute_is_duplicate_flag[ index ][ i ], | ae(v) |
| AttrPacketPtr | |
| } | |
| } | |
| } | |

### I.8.3.16 Padding to Byte Alignment Syntax

| | Descriptor |
|---|---|
| padding_to_byte_alignment( ) { | |
| while( !byte_aligned( ) ) | |
| padding_to_byte_alignment_bit_equal_to_zero | f(1) |
| /* equal to 0 */ | |
| } | |

### I.8.4 Semantics

### I.8.4.1 General Mesh Coding Semantics

None.

### I.8.4.2 Mesh Coding Header Semantics

mesh_codec_type indicates the identifier of the selected codec method. Table I-2 describes the list of supported methods.

TABLE I-2
Mesh codec types

| mesh_codec_type | Identifier | Codec Type |
|---|---|---|
| 0 | CODEC_TYPE_REVERSE | Reverse |
| 1 . . . 3 | CODEC_TYPE_RESERVED | Reserved |

mesh_vertex_traversal_method specifies the method used to traverse the vertices to perform the prediction of all the vertex positions and vertex attributes. Table I-3 describes the list of supported methods.

TABLE I-3
Mesh vertex traversal methods

| mesh_vertex_traversal_method | Identifier | Traversal Method |
|---|---|---|
| 0 | MESH_TRAVERSAL_EB | Use Edge Breaker |
| | | connectivity traversal |
| | | as vertex order |
| 1 | MESH_TRAVERSAL_DEGREE | Use prediction degree |
| | | traversal as vertex |
| | | order |
| >1 | MESH_TRAVERSAL_RESERVED | Reserved |

mesh_position_dequantize_flag equal to 1 specifies that the decoded three-dimensional (3D) position shall be dequantized using bounding box information. mesh_position_dequantize_flag equal to 0 specifies that decoded 3D position coordinates are (quantized) unsigned integers.

mesh_entropy_packets_enable_flag equal to 1 specifies that the arithmetically coded data corresponding to the attribute payload for each mesh attribute type (e.g., MESH_ATTR_TEXCOORD, MESH_ATTR_NORMAL, MESH_ATTR_MATERIAL_ID) is contiguous in the bitstream. The continuous data is referred to as an entropy packet. The arithmetically coded data corresponding to the position payload and attribute payload corresponding to attribute types “MESH_ATTR_COLOR” and “MESH_ATTR_GENERIC” is also contiguous in the bitstream and forms another entropy packet. mesh_entropy_packets_enable_flag equal to 0 specifies that the arithmetically coded data corresponding to the mesh position payload and texture payload corresponding to all the texture types is contiguous in the bitstream and forms a single packet. EntropyPacketPtr is a variable pointing to the current position in the entropy packet associated with the position coding payload or attribute coding payload for attributes of type “MESH_ATTR_COLOR” or “MESH_ATTR_GENERIC.”

mesh_attribute_count indicates the number of encoded attributes.

mesh_attribute_type[i] indicates the attribute type of the i^{th} attribute where i is in the range 0 to 7. Table I-4 describes the list of supported attribute types.

TABLE I-4
Mesh attribute types

| mesh_attribute_type[i] | Identifier | Attribute type |
|---|---|---|
| 0 | MESH_ATTR_TEXCOORD | Texture Coordinate |
| 1 | MESH_ATTR_NORMAL | Normal |
| 2 | MESH_ATTR_COLOR | Color |
| 3 | MESH_ATTR_MATERIAL_ID | Material ID |
| 4 | MESH_ATTR_GENERIC | Generic |
| 5 . . . 6 | MESH_ATTR_RESERVED | Reserved |
| 7 | MESH_ATTR_UNSPECIFIED | Unspecified |

Note
Generic attributes will have their number of components specified by the value of the corresponding mesh_attribute_generic_num_components_minus1[index]. Other attributes have a fixed number of components

mesh_normal_octahedral_flag[i] equal to 1 indicates the normal attributes shall be decoded using octahedral representation. mesh_normal_octahedral_flag[i] equal to 0 indicates that the normal attributes shall be decoded in 3D cartesian coordinates.

mesh_attribute_num_componetns_minus1[i] plus 1 specifies the number of components of the i^{th} attribute when mesh_attribute_type[i] is equal to MESH_ATTR_GENERIC.

mesh_attribute_dequanitze_flag[i] equal to 1 specifies that the decoded attributes with index i shall be dequantized using bounding box information. mesh_attribute_dequantize_flag[i] equal to 0 specifies that decoded components of attributes with index i are (quantized) unsigned integers.

mesh_deduplicate_method specifies that the method used to deduplicate positions and attributes. Table I-5 describes the list of supported methods.

TABLE I-5
Mesh deduplication methods

| mesh_deduplicate_method | Identifier | Prediction Method |
|---|---|---|
| 0 | MESH_DEDUP_NONE | None |
| 1 | MESH_DEDUP_DEFAULT | Default |
| >0 | MESH_DEDUP_RESERVED | Reserved |

### I.8.4.3 Mesh Position Encoding Parameters Semantics

mesh_position_bit_depth_minus1 specifies the number of bits used to represent 3D position coordinates.

mesh_position_prediction_method specifies the method used to predict vertex positions and compute residuals mesh_position_fine_residuals[i][j], and mesh_position_coarse_residual[i][j]. Table I-6 describes the list of supported methods

| mesh_position_prediction_method | Identifier | Prediction Method |
|---|---|---|
| 0 | MESH_POSITION_MPARA | Multiple |
| | | Parallelograms |
| >0 | MESH_POSITION_RESERVED | Reserved |

mesh_position_reverse_unfication_flag equal to 1 indicates that the duplicated position shall be recovered. mesh_position_reverse_unification_flag equal to 0 indicates that the duplicated positions shall not be recovered.

### I.8.4.4 Mesh Position Dequantize Parameters Semantics

mesh_position_min[i] specifies a lower bound to the value of the dequantized i^{th} component of 3D positions. When not present mesh_position_min[i] is inferred to be equal to −1. A quantized position i^{th} component value of 0 will be mapped to mesh_position_min[i] after dequantization.
mesh_position_max[i] specifies an upper bound to the value of the dequantized i^{th} components of 3D positions. When not present mesh_position_min[i] is inferred to be equal to +1. A quantized position i^{th} component value of k will be mapped to mesh_position_min[i] plus k times PositionValueStep where PositionValueStep is defined as follows:

◯ positionValueRange = 0
◯ maxPositionQuantizedValue = (1 << (mesh_position_bit_depth_minus1 + 1)) − 1
◯ for ( i=0; i<3; i++) {

▪ positionValueRange = Max ( positionValueRange,

▪ mesh_position_max[i] − mesh_position_min[i])

◯ }
◯ PositionValueStep = positionValueRange ÷ maxPositionQuantizedValue

### I.8.4.5 Mesh Attributes Encoding Parameters Semantics

mesh_attribute_bit_depth_minus1[i] plus 1 specifies the number of bits used to represent the components of the i^{th} attribute.
mesh_attribute_per_face_flag[i] equal to 1 indicates that the i^{th} attribute has values defined per face. mesh_attribute_per_face_flag[i] equal to 0 indicates that the i^{th} attribute has values defined per vertex. Note 1—When attributes are defined per face there is no index ambiguity. When attributes are defined per vertex, they can each have their own set of indices.
mesh_attribute_separate_index_flag[i] equal to 1 specifies if the i^{th} attribute as a specific index sequence attached. mesh_attribute_separate_index_flag[i] equal to 0 specifies that the i^{th} attribute indices are replicated from either the position indices or the indices of another attribute. When mesh_attribute_per_face_flag[i] is equal to 1 mesh_attribute_separate_index_flag[i] is set to its default value 0.
mesh_attribute_reference_index_plus1[i] minus 1 specifies the reference index for the i^{th} attribute when mesh_attribute_separate_index_flag[i] is equal to 0. When equal to −1 the reference index is the position index, otherwise it specifies the attribute from which the index is used as reference. It is a requirement of bitstream conformance that mesh_attribute_reference_index_plus1[i] minus 1 shall be less than i.
mesh_attribute_prediction_method[i] specifies the method used to predict the i^{th} attribute values and compute residuals mesh_attribute_fine_residual[i][j][k] and mesh_attribute_fine_residual[i][j][k]. Table I-7 describes the list of supported methods for attributes with mesh_attribute_type equal to MESH_ATTR_TEXCOORD, Table I-8 for attributes with mesh_attribute_type equal to MESH_ATTR_NORMAL, Table I-9 for attributes with mesh_attribute_type equal to MESH_ATTR_COLOR, Table I-10 for attributes with mesh_attribute_type equal to MESH_ATTR_MATERIAL_ID, Table I-11 for attributes with mesh_attribute_type equal to MESH_ATTR_GENERIC.

TABLE I-7
Mesh attribute prediction methods for MESH_ATTR_TEXCOORD type attributes

| mesh_attribute_prediction_method[i] | Identifier | Prediction Method |
|---|---|---|
| 0 | MESH_TEXCOORD_MSTRETCH | Stretch |
| >0 | MESH_TEXCOORD_RESERVED | Reserved |

TABLE I-8
Mesh attribute prediction methods for MESH_ATTR_NORMAL type attributes

| mesh_attribute_prediction_method[i] | Identifier | Prediction Method |
|---|---|---|
| 0 | MESH_NORMAL_DELTA | Delta Coding |
| 1 | MESH_NORMAL_MPARA | Multiple |
| | | parallelograms |
| 2 | MESH_NORMAL_CROSS | Cross product |
| >2 | MESH_NORMAL_RESERVED | Reserved |

TABLE I-9
Mesh attribute prediction methods for MESH_ATTR_COLOR type attributes

| mesh_attribute_prediction_method[i] | Identifier | Prediction Method |
|---|---|---|
| 0 | MESH_COLOR_DEFAULT | Default (TODO) |
| >0 | MESH_COLOR_RESERVED | Reserved |

TABLE I-10
Mesh attribute prediction methods for MESH_ATTR_MATERIAL_ID type attributes

| mesh_attribute_prediction_method[i] | Identifier | Prediction Method |
|---|---|---|
| 0 | MESH_MATERIALID_DEFAULT | Default |
| >0 | MESH_MATERIALID_RESERVED | Reserved |

TABLE I-11
Mesh attribute prediction methods for MESH_ATTR_GENERIC type attributes

| mesh_attribute_prediction_method[i] | Identifier | Prediction Method |
|---|---|---|
| 0 | MESH_GENERIC_DEFAUT | Delta Coding |
| 1 | MESH_GENERIC_MPARA | Multiple |
| | | parallelograms |
| >1 | MESH_GENERIC_RESERVED | Reserved |

### I.8.4.6 Mesh Attribute Dequantize Parameters Semantics

Mesh_attribute_min[index][j] specifies a lower bound to the value of the dequantized j^{th} components of the index-th attribute. When not present mesh_attribute_min[index][j] is inferred to be equal to −1. A quantized index-th attribute j^{th} component value of 0 will be mapped to mesh_attribute_min[index][j] after dequantization.
mesh_attribute_max[index][j] specifies an upper bound to the value of the dequantized j^{th} components of the index-th attribute. When not present mesh_attribute_max[index][j] is inferred to be equal to +1. A quantized index-th attribute j^{th} component value of k will be mapped to mesh_attribute_min[index][j] plus k times Attribute ValueStep[index] where Attribute ValueStep[index] is defined as follows:

◯ attributeValueRange[index] = 0
◯ maxAttributeQuantizedValue[index] =

◯ (1<<(mesh_attribute_bit_depth_minus1[index]+1)) − 1

◯ for (j=0; j < NumComponents[index]; j++){

▪ attributeValueRange[index] = Max (attributeValueRange[index],

● mesh_attribute_max[index][j]−mesh_attribute_max[index][j])

◯ }
◯ AttributeValueStep[index] =

▪ attributeValueRange[index] ÷ maxAttributeQuantizedValue[index]

### I.8.4.7 Mesh Position Coding Payload Semantics

mesh_triangle_count specifies the number of triangles in the decoded mesh.
mesh_position_start_count specifies the number of start positions.
mesh_position_fine_residuals_count specifies the size of the mesh_position_fine_residual array containing fine residual values for the 3 components of the predicted positions.
mesh_position_coarse_residuals_count specifies the size of the mesh_position_coarse_residual array containing coarse residual values for the 3 components of the predicted positions.
mesh_clers_count specifies the number of encoded CLERS symbols.
mesh_cc_with_boundary_count specifies the number of connected components with boundaries comprised in the coded mesh. The number of components without boundaries is deduced from the decoded CLERS symbols sequence (see clause 1.9.3).
mesh_handles_count[i] specifies the number of handles comprised in the i-th connected component with non zero handle count.
mesh_handle_first_delta[i] specifies the difference between the i-th handle first corner and the (i−1)-th handle first corner when i is greater than 0. When i is equal to 0 mesh_handle_index_second_delta[0] specifies the first handle first corner.
mesh_handle_second_delta[i] specifies the difference between the i-th handle second corner and the (i−1)-th handle second corner when i is greater than 0. When i is equal to 0 mesh_handle_index_second_delta[0] specifies the first handle second corner.
mesh_position_packet_size specifies the size in bytes of the arithmetically coded data, including the final byte alignment, corresponding to the mesh position coding payload and mesh attribute coding payload corresponding to attribute types “MESH_ATTR_COLOR” and “MESH_ATTR_GENERIC”.
mesh_all_packet_size specifies the size in bytes of the arithmetically coded data, including the final byte alignment, corresponding to the mesh position coding payload and mesh attribute coding payload corresponding to all attribute types.
mesh_handle_first_sign[i] specifies if the handle is associated with a boundary or not. When mesh_handle_first_sign[i] is equal to 0, the corner index associated with the i-th handle first corner will be smaller than zero, indicating that the handle is associated with a boundary. When mesh_handle_first_sign[i] is equal to 1, the corner index associated with the i-th handle first corner will be greater than zero, indicating that the handle is not associated with a boundary.
mesh_handle_second_shift[i] specifies the shift to apply when computing the corner index associated with the i-th handle second corner.
   Note-Handle indices are relative to a triangle/face index as related corner indices can be deduced implicitly. The corner index of the first handle is conforming to either (3*T+2) or (−3*T−2). The corner index of the second handle f index is conforming to either (3*T+1) or (3*T+2). mesh_handle_first_sign[i] and mesh_handle_index_second_shift[i] are used to discriminate those cases
mesh_handle_first_variable_delta_length4_minus1[i] specifies the number of groups of four bits used to represent mesh_handle_first_variable_delta[i].
mesh_handle_first_variable_delta[i] specifies an intermediate value used to evaluate the corner index associated with the i-th handle first corner. The number of bits used to represent mesh_handle_first_variable_delta[i] is equal to (4*(mesh_handle_index_first_variable_delta_length4_minus1+1)).
mesh_handle_index_second_variable_delta_length4_minus1[i] specifies the number of groups of four bits used to represent mesh_handle_second_variable_delta[i].
mesh_handle_second_variable_delta[i] specifies an intermediate value used to evaluate the corner index associated with the i-th handle second corner. The number of bits used to represent mesh_handle_second_variable_delta[i] is equal to (4*(mesh_handle_index_second_variable_delta_length4_minus1+1)).
mesh_clers_symbol[i] specifies the value of the i-th CLERS symbol. The values are positive integers interpreted as specified by Table I-12.

TABLE I-12
Interpretation of mesh_clers_symbol[i]

| mesh_clers_sumbol[i] | Identifier |
|---|---|
| 0 | CLERS_C |
| 1 | CLERS_R |
| 3 | CLERS_S |
| 7 | CLERS_L |
| 15 | CLERS_E |
| other values | CLERS_RESERVED |

mesh_position_start[i][j] specifies the value of the j-th component of the first position of the i-th connected component as an unsigned integer coded using mesh_position_bit_depth_minus1+1 bits.
mesh_position_fine_residual[i][j] specifies the value of the i-th fine position prediction residual associated with the j-th component.
mesh_position_coarse_residual[i][j] specifies the value of the i-th coarse prediction residual associated with the j-th component.

### I.8.4.8 Mesh Position Deduplicate Information Semantics

mesh_position_deduplicate_count specifies the number of duplicated vertices
   Note—The number of duplicated vertices is the sum of the number of original vertices that be been split, and the number of vertices added during the process of duplication to fix the manifoldness of the mesh.
mesh_position_deduplicate_idx[i] specifies a value that is common to duplicated vertices sharing a common parent. mesh_position_deduplicate_idx[i] values range from 0 to the number of original vertices that have been split minus one.
mesh_position_is_duplicate_flag[i] equal to 1 specifies that the i-th decoded vertex is a duplicated vertex. mesh_position_is_duplicate_flag[i] equal to 0 specifies that the i-th decoded vertex is not a duplicated vertex.

### I.8.4.9 Mesh Difference Information Syntax

mesh_position_added_vertices_count specifies the number of added vertices.
   Note—The number of added vertices is the number of vertices that shall be added to the reconstructed mesh as first.
mesh_position_added_vertices_idx_delta[i] specifies the difference between the values of the i-th added point index and the (i−1)-th added point index when i is greater than 0. When i equals 0, mesh_position_added_vertices_idx_delta[0] specifies the value of the index of the first added point.
mesh_position_deleted_vertices_count specifies the number of deleted vertices
   Note—The number of deleted vertices is the number of vertices of the reconstructed mesh at first that shall be deleted.
mesh_position_deleted_vertices_idx_delta[i] specifies the difference between the values of the i-th deleted point index and the (i−1)-th deleted point index when i is greater than 0. When i equals 0, mesh_position_deleted_vertices_idx_delta[0] specifies the value of the index of the first deleted point.
mesh_modified_count specifies the number of modified information.
   Note—The number of modified information is the number of times the triangles that shall be modified in the reconstructed mesh at first.
mesh_modified_triangles_idx_delta[i] specifies the difference between the values of the i-th modified triangle index and the (i−1)-th modified triangle index when i is greater than 0. When i equals 0, mesh_modified_triangles_idx_delta[0] specifies the value of the index of the first modified triangle.
mesh_modified_vertices_relative_idx[i] specifies the value of the i-th modified point relative index in the i-th modified triangles. Its range is [0, 1, 2].
mesh_target_modified_vertices_idx_delta[i] specifies the difference between the values of the i-th target point index and the (i−1)-th target point index when i is greater than 0. When i equals 0, mesh_target_modified_vertices_idx_delta[0] specifies the value of the index of the first target point index.
   Note—The i-th target point index is the index of the i-th target point in the reconstructed mesh at first that the i-th modified point shall be modified to.

### I.8.4.10 Mesh Attribute Coding Payload Semantics

mesh_attribute_start_count[i] specifies the size of the mesh_attribute_start[i] array containing attribute values which are not predicted.
mesh_attribute_fine_residuals_count[i] specifies the size of the mesh_attribute_fine_residual[i] array containing fine residual values for the NumResidualsComponents[i] components of the i-th attribute.
mesh_attribute_coarse_residuals_count[i] specifies the size of the mesh_attribute_coarse_residual[i] array containing coarse residual values for the NumResidualsComponents[i] components of the i-th attribute.
AttrPacketPtr is a variable pointing to the current position in the entropy packet associated with the attribute for which attribute coding payload is being processed.
mesh_uv_packet_size specifies the size in bytes of the arithmetically coded data, including the final byte alignment, for the mesh attribute coding payload corresponding to the attribute type “MESH_ATTR_TEXCOORD”.
mesh_normal_packet_size specifies the size in bytes of the arithmetically coded data, including the final byte alignment, for the mesh attribute coding payload corresponding to the attribute type “MESH_ATTR_NORMAL.”
mesh_uv_packet_size specifies the size in bytes of the arithmetically coded data, including the final byte alignment, for the mesh attribute coding payload corresponding to the attribute type “MESH_ATTR_MATERIAL_ID.”
mesh_attribute_seams_count[i] specifies the size of the i-th attribute mesh_attribute_seam array.
mesh_coded_attribute_seams_size[i] specifies the size in bytes of the arithmetically coded sequence of binary seam indications mesh_attribute_seam[i][j], including the final byte alignment.
mesh_attribute_seam[i][j] specifies the value of the j-th binary seam indication of the i-th attribute.
mesh_attribute_start[i][j][k] specifies the value of the k-th component of j-th value not predicted for the i-th attribute and the value of the k-th component as an unsigned integer coded using mesh_attribute_bit_depth_minus1[i]+1 bits.
mesh_attribute_fine_residual[i][j][k] specifies the value of the k-th component of the j-th fine prediction residual associated with the i-th attribute.
mesh_attribute_coarse_residual[i][j][k] specifies the value of the k-th component of the j-th coarse prediction residual associated with the i-th attribute. When not present, mesh_attribute_coarse_residual[i][j][k] is inferred to be equal to 0.

### I.8.4.11 Mesh Attribute Extra Data Semantics

### I.8.4.12 Mesh Texcoord Stretch Extra Data Semantics

mesh_texcoord_stretch_orientations_count[i] specifies the size of the array containing orientation information mesh_texcoord_stretch_orientation used to predict texture coordinates when the mesh_attribute_type of the i-th attribute is equal to MESH_ATTR_TEXCOORD and when the related mesh_attribute_prediction_method is equal to MESH_TEXCOORD_MSTRETCH.
mesh_texcoord_stretch_orientation[i][j] specifies the value of the j-th orientation bit in the sequence used to generate the i-th attribute values from the arrays mesh_attribute_residual[i], and mesh_attribute_start[i].

### I.8.4.13 Mesh Materialid Default Extra Data Semantics

mesh_materialid_default_not_equal_count[i] specifies the size of the array containing boolean information mesh_materialid_default_not_equal_flag used to predict material ids when the mesh_attribute_type of the i-th attribute is equal to MESH_ATTR_MATERIAL_ID and when the related mesh_attribute_prediction_method is equal to MESH_MATERIALID_DEFAULT.
mesh_materialid_default_left_count[i] specifies the size of the array containing boolean information mesh_materialid_default_left_flag used to predict material ids when the mesh_attribute_type of the i-th attribute is equal to MESH_ATTR_MATERIAL_ID and when the related mesh_attribute_prediction_method is equal to MESH_MATERIALID_DEFAULT.
mesh_materialid_default_right_count[i] specifies the size of the array containing boolean information mesh_materialid_default_right_flag used to predict material ids when the mesh_attribute_type of the i-th attribute is equal to MESH_ATTR_MATERIAL_ID and when the related mesh_attribute_prediction_method is equal to MESH_MATERIALID_DEFAULT.
mesh_materialid_default_facing_count[i] specifies the size of the array containing boolean information mesh_materialid_default_facing_flag used to predict material ids when the mesh_attribute_type of the i-th attribute equal to MESH_ATTR_MATERIAL_ID and when the related mesh_attribute_prediction_method equal to MESH_MATERIALID_DEFAULT.
mesh_coded_materialid_default_not_equal_size[i] specifies the size in bytes of the arithmetically coded sequence of booleans contained in the array mesh_materialid_default_not_equal_flag[i], including the final byte alignment.
mesh_materialid_default_not_equal_flag[i][j] specifies the value of the j-th bit in the sequence used to generate the i-th attribute value from the arrays mesh_attribute_residual[i], and mesh_attribute_start[i].
mesh_materialid_default_left_flag[i][j] specifies the value of the j-th bit in the sequence used to generate the i-th attribute value from the arrays mesh_attribute_residual[i], and mesh_attribute_start[i].
mesh_materialid_default_right_flag[i][j] specifies the value of the j-th bit in the sequence used to generate the i-th attribute value from the arrays mesh_attribute_residual[i], and mesh_attribute_start[i].
mesh_materialid_default_facing_flag[i][j] specifies the value of the j-th bit in the sequence used to generate the i-th attribute value from the arrays mesh_attribute_residual[i], and mesh_attribute_start[i].

### I.8.4.14 Mesh Normal Octahedral Extra Data Semantics

mesh_normal_octahedral_bit_depth_minus1[i] plus 1 specifies the number of bits used to represent normal attribute when the mesh_attribute_type of the i-th attribute is equal to MESH_ATTR_NORMAL and when the related mesh_normal_octahedral_flag is equal to 1.
mesh_normal_octahedral_second_residual_flag[i] equals to 1 indicates that the second residual for normals shall be decoded. mesh_normal_octahedral_second_residual_flag[i] equals to 0 indicates that the second residual for normals shall not be decoded. This shall happen when the mesh_attribute_type of the i-th attribute is equal to MESH_ATTR_NORMAL and when the related mesh_normal_octahedral_flag is equal to 1.
mesh_normal_octahedral_second_residuals_count[i] specifies the size of the mesh_normal_octahedral_second_residual[i] array containing residual values for three components when the mesh_attribute_type of the i-th attribute is equal to MESH_ATTR_NORMAL and when the related mesh_normal_octahedral_flag is equal to 1.
mesh_normal_octahedral_second_residual[i][j][k] specifies the value of the residual associated with the k-th component of the j-th value of the i-th attribute when the mesh_attribute_type of the i-th attribute is equal to MESH_ATTR_NORMAL and when the related mesh_normal_octahedral_flag is equal to 1.

### I.8.4.15 Mesh Attribute Deduplicate Information Semantics

mesh_attribute_deduplicate_count[i] specifies the number of duplicated attribute vertices for the i-th attribute.
mesh_attribute_deduplicate_idx[i][j] specifies a value that is common to duplicated attribute vertices for the i-th attribute, sharing a common parent. mesh_attribute_deduplicate_idx[i][j] values range from 0 to the number of original attribute vertices that have been split minus one.
mesh_attribute_is_duplicate_flag[i][j] equal to 1 specifies that the j-th decoded attribute vertex of the i-th attribute is a duplicated attribute vertex.

### I.8.4.16 Padding to Byte Alignment Syntax

padding_to_byte_alignment_bit_equal_to_zero shall be equal to zero.

### *End of Syntax and Semantics

In at least one embodiment, separate entropy packets are utilized to transmit color attributes and generic attributes. For example, separate entropy packets are used for mesh color attributes (mesh_attribute_type==MESH_ATTR_COLOR) and for generic mesh attributes (mesh_attribute_type==MESH_ATTR_GENERIC). In at least one embodiment, when the value of the entropy packets flag (e.g., mesh_entropy_packets_enable_flag) is one ‘1,’ a separate packet is used for each attribute. In such embodiment, if two attributes have a same attribute type (e.g., mesh_attribute_type==MESH_ATTR_TEXCOORD), they would be in separate packets still. In other embodiments, when the value of the entropy packet flag is zero ‘0,’ the arithmetic coded data corresponding to all of the attribute of a particular type (e.g., mesh_attribute_type==MESH_ATTR_TEXCOORD) belong to a single packet.

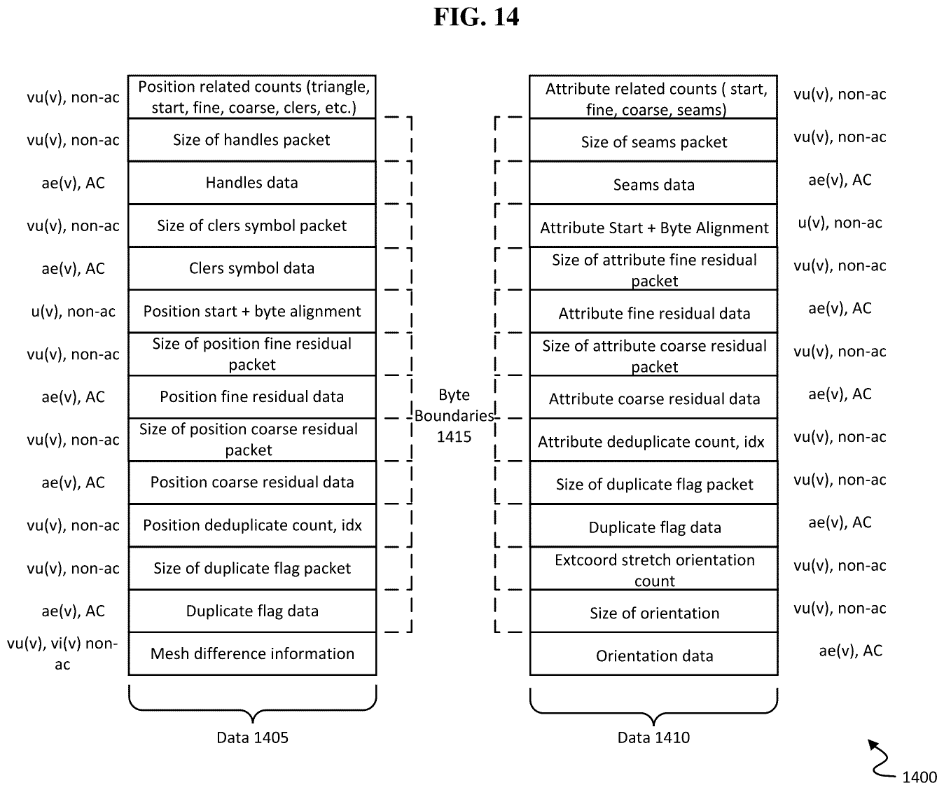

FIG. 14 illustrates example entropy packets in video-based dynamic mesh coding (V-DMC). In at least one embodiment, packets 1400 have a format indicated in V-DMC TMM 7.0. The packets 1400 can be used to transmit one or more prediction errors (e.g., the prediction errors discussed with reference to FIGS. 6 and 7). In some embodiments, the prediction error associated with FIG. 14 is a texture coordinate prediction error. In other embodiments, other prediction errors are possible—e.g., FIG. 14 illustrates one example for clarification but is not limiting.

As described with reference to FIGS. 8-13, basemesh data can be binarized before being packed and transmitted. In one embodiment, the following binarizations are used for the prediction error packets: u(n), u(v), uc (v), vi(v), vu(v), fl(n), and ae(v). In some embodiments, arithmetic-coded data (AC) is indicated by the binarization ae(v). In such embodiments, the remaining binarizations (e.g., u(n), u(v), uc (v), vi(v), vu(v), and fl(n)) denote non-AC data. In at least one embodiment, a mesh coding header (e.g., the mesh_coding_header( ) described with reference to FIG. 13 and the syntax and semantics described herein), contains non-AC data—e.g., the mesh coding header does not include any AC data. Accordingly, signaling of syntax elements in the mesh coding header are not changed. In at least one embodiment, a mesh position (e.g., mesh_position_coding_payload( )) and a mesh attribute (e.g., mesh_attribute_coding_payload( )) include both AC coded data and non-AC coded data.

In some embodiments, the AC-coded data binarization is used to convert syntax elements into bins (e.g., binary symbols), and then the binary symbols can be coded using a binary arithmetic coding scheme—e.g., a binary arithmetic coding scheme defined in V-DMC TMM 8.0 annex K. In at least one embodiment, AC-coded data starts at a byte boundary and a termination process for the arithmetic coding (e.g., the ACE 820 as described with reference to FIG. 8) ensure the AC-coded data also ends at a byte boundary. In some examples, non-AC coded data can also be aligned to a byte boundary. For example, if a segment that follows the non-AC coded data is AC-coded data, alignment of the non-AC coded data is done so the AC-coded data can start at the byte boundary.

For example, FIG. 14 illustrates data 1405 corresponding to a geometry prediction error (e.g., mesh position (mesh_position_coding_payload( )) and data 1410 illustrating a texture coordinate prediction error (e.g., mesh attribute (mesh_attribute_coding_payload( )). In at least one embodiment, the data 1405 can include syntax elements and data that is non-AC coded or syntax elements and data that is AC-coded. For example, the data 1405 can include a size of handle packets that is non-AC coded data and handles data that is AC coded data—e.g., denoted by vu(v), non-ac and ae(v), AC, respectively. Similarly, data 1410 can include both non-AC coded data and AC-coded data—e.g., include non-AC coded data size of seams packet and include AC-coded data attribute fine residual data. In at least one embodiment, data 1405 and 1410 include each syntax or element in a different byte boundary—e.g., each syntax or element can be transmitted in a separate packet. For example, byte boundaries 1415 illustrate that AC-coded data starts at a boundary and ends at a boundary for both data 1405 and data 1410. In at least one embodiment, the syntax and elements illustrated in FIG. 14 are described with reference to the syntax and semantics presented in reference to FIG. 13.

As described with reference to FIG. 9, a syntax element (e.g., a mesh entropy enable flag (mesh_entropy_packets_enable_flag)) can be set as a one ‘1’ or a zero ‘0.’ In at least one embodiment, depending on the value of the mesh entropy enable flag, the AC-coded data can be packed into a single packet (e.g., when the value of the mesh entropy enable flag is zero ‘0’) or the AC-coded data can be split into several packets corresponding to position coding payload and attribute coding payload for each attribute (e.g., when the value of the mesh entropy enable flag is one ‘1’). In such embodiments, a number of packets is equal to a mesh attribute count plus one—e.g., mesh_attirbute_count+1).

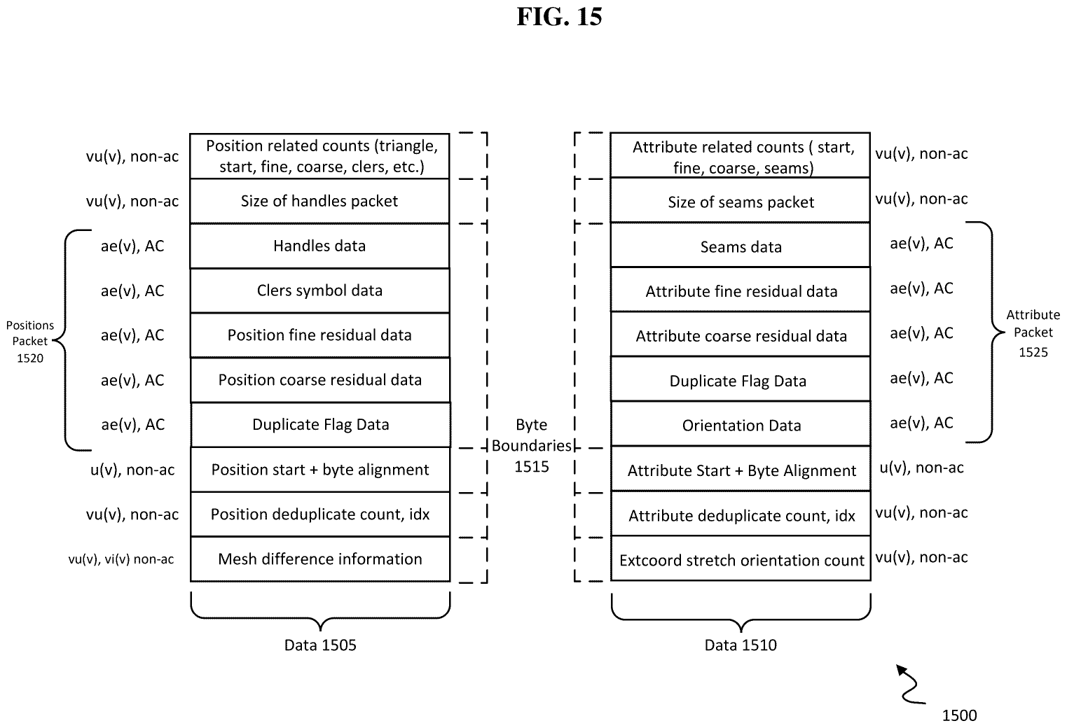

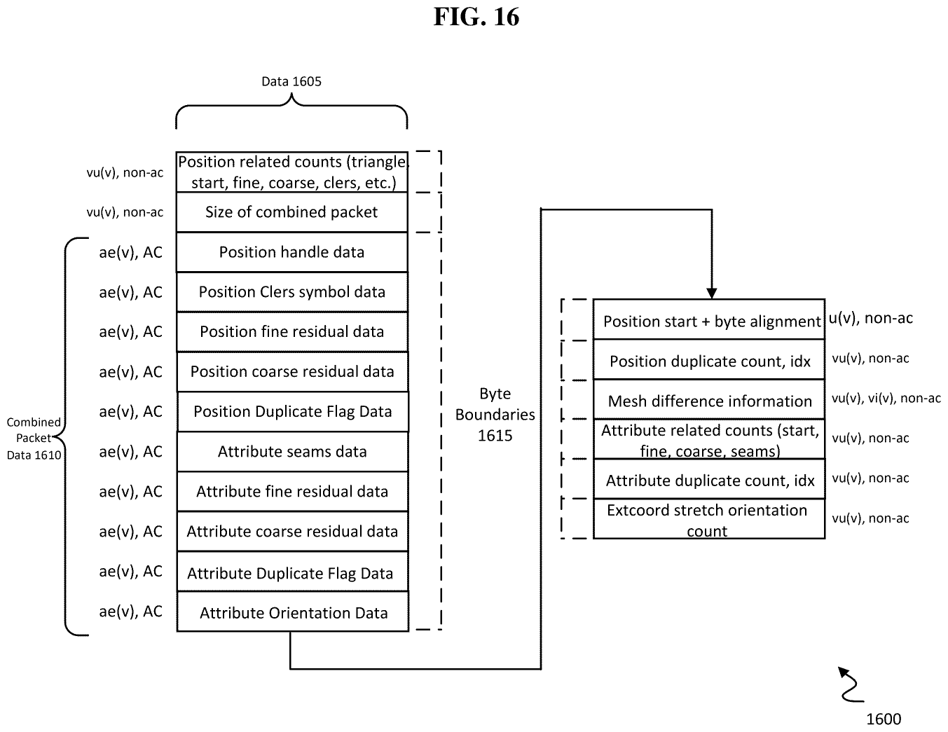

In at least one embodiment, FIG. 15 illustrates the format of the packets when the mesh entropy enable flag is set at one ‘1.’ In at least one embodiment, FIG. 16 illustrates the format of the packets when the mesh entropy flag is set at zero ‘0,’

FIG. 15 illustrates example entropy packets in video-based dynamic mesh coding (V-DMC). In at least one embodiment, packets 1500 have a format indicated in V-DMC DIS. The packets 1500 can be used to transmit one or more prediction errors (e.g., the prediction errors discussed with reference to FIGS. 6 and 7). In some embodiments, the prediction error associated with FIG. 15 is a geometry prediction error and a texture coordinate prediction error—e.g., for one texture of type MESH_ATTR_TEXCOORD. In one embodiment, data 1505 is associated with the geometry prediction error and data 1510 is associated with the texture coordinate prediction error. In other embodiments, other prediction errors are possible—e.g., FIG. 15 illustrates one example for clarification but is not limiting. In at least one embodiment, FIG. 15 illustrates a scenario when the mesh entropy flag is set at one ‘1.’

For example, when the mesh entropy enable flag is one ‘1,’ AC coded data for a respective attribute is packed into an individual packet. In one embodiment, data 1505 illustrates a mesh position (e.g., mesh_position_coding_payload( )) and data 1510 illustrates a mesh attribute (e.g., mesh_attribute_coding_payload( )). In at least one embodiment, the positions AC-coded data is packed into positions packet 1520—e.g., the handles data, CLERS symbol data, position fine residual data, position coarse residual data, and the duplicate flag data are packed into the positions packet 1520. In such embodiments, the positions packet can have a single start byte boundary and a single end byte boundary—e.g., there is not a need to pack an entropy header or an arithmetic start/arithmetic end (e.g., ACS or ACE) between each AC-coded data segment. Similarly, attributes AC-coded data is packed into attribute packet 1525—e.g., the seams data, attribute fine residual data, attribute coarse residual data, duplicate flag data, and orientation data is packed into attribute packet 1525. By setting the value of the mesh entropy enable flag to one ‘1,’ each AC-coded attribute is packed into a respective entropy packet. Additionally, non-AC coded syntax elements that were positioned between the AC-coded data segments are moved and positioned after the AC-coded data for the position coding payload and the attribute coding payload.

FIG. 16 illustrates example entropy packets in video-based dynamic mesh coding (V-DMC). In at least one embodiment, packets 1600 have a format indicated in V-DMC DIS. The packets 1600 can be used to transmit one or more prediction errors (e.g., the prediction errors discussed with reference to FIGS. 6 and 7). In some embodiments, the prediction error associated with FIG. 16 is a geometry prediction error and a texture coordinate prediction error—e.g., for one texture of type MESH_ATTR_TEXCOORD. In one embodiment, data 1605 is associated with both the geometry prediction error and the texture coordinate prediction error. In other embodiments, other prediction errors are possible—e.g., FIG. 16 illustrates one example for clarification but is not limiting. In at least one embodiment, FIG. 16 illustrates a scenario when the mesh entropy flag is set at zero ‘0.’

For example, when the mesh entropy enable flag is zero ‘0,’ all AC coded data is packed into a combined packet—e.g., combined data packet 1610. In at least one embodiment, data 1605 includes data for both the mesh position (e.g., mesh_position_coding_payload( )) and the mesh attribute (e.g., mesh_attribute_coding_payload( )). That is, all of the AC-coded data associated with both the position and attribute payload is packed into a single combined packet 1610. In such embodiments, the combined packet data 1610 can have a single start byte boundary 1615 and a single end byte boundary 1615—e.g., the AC-coded data is packed without an entropy header or an arithmetic start/stop operation between each AC-coded data segment. In at least one embodiment, all of the non-AC coded data for both the mesh position and mesh attributes is positioned after the combined packet data 1610. In at least one embodiment, the combined packet data 1610 can include the position handle data, position CLERS symbols, position fine residual data, position coarse residual data, position duplicate flag data, attribute seams data, attribute fine residual data, attribute coarse residual data, attribute duplicate flag data, and attribute orientation data. In other embodiments, the combined packet data 1610 can include additional syntax or data or include a subset or portion of the combined packet data 1610 shown.

In at least some embodiments, the arithmetic decoder can use syntax elements in the non-AC coded segments. In one embodiment, the arithmetic decoder may use the syntax elements in the non-AC coded segments to decode the AC-coded data segments. In one embodiment, the decoder can buffer the AC-coded data segments and decode the non-AC coded syntax elements before decoding some of the AC-coded data segments. In such embodiments, the decoder can keep track of whether AC-coded data or non-AC coded data is being parsed and from which buffer it should be read.

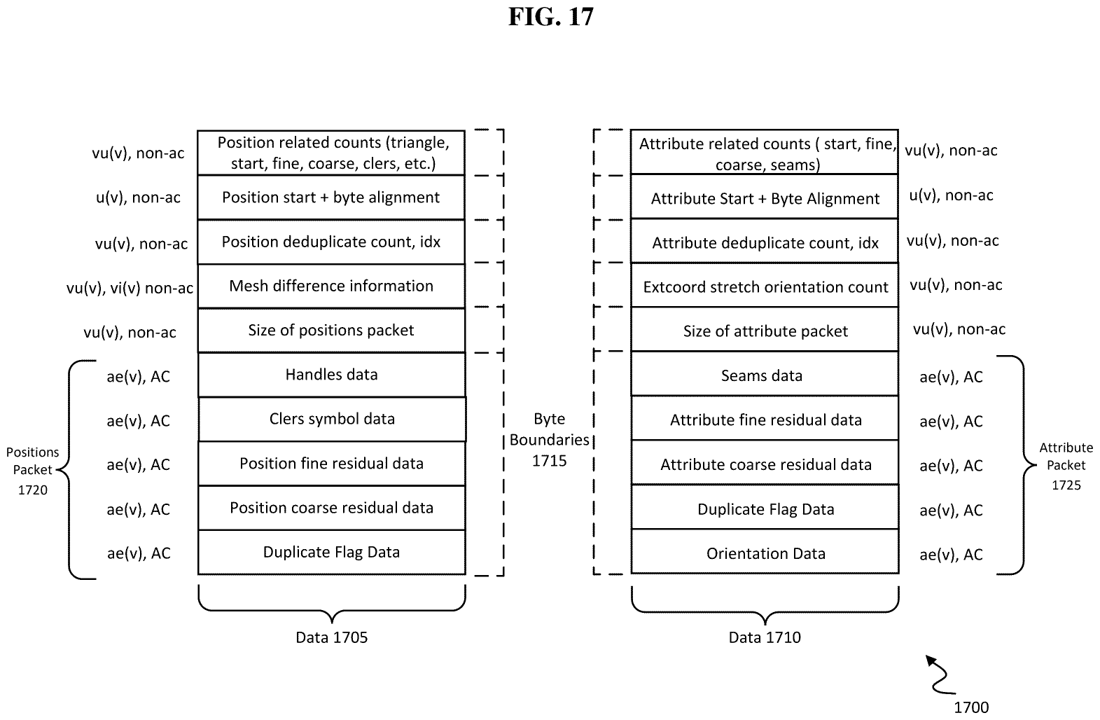

In other embodiments, to overcome having to decode some of the non-AC coded syntax elements first, an encoder can encode the non-AC coded syntax elements in the bitstream before the AC-coded data. In one embodiment, FIG. 17 illustrates one possible embodiment where the mesh entropy enable flag (e.g., mesh_entropy_packet_enable_flag) is set to one ‘1’ and the non-AC coded syntax elements are coded before the AC-coded data. For example, for data 1705 (e.g., for the position coding payload), the non-AC coded data are coded before the position packet 1720. (e.g., before the position entropy packet containing all of the AC-coded data segments). In some embodiments, data 1710 (e.g., data for the attribute coding payload), all of the non-AC coded data is coded before the attribute packet 1725 (e.g., before the attribute packet containing all of the AC-coded data segments). In at least one embodiment, a size of a last attribute entropy packet is not signaled.

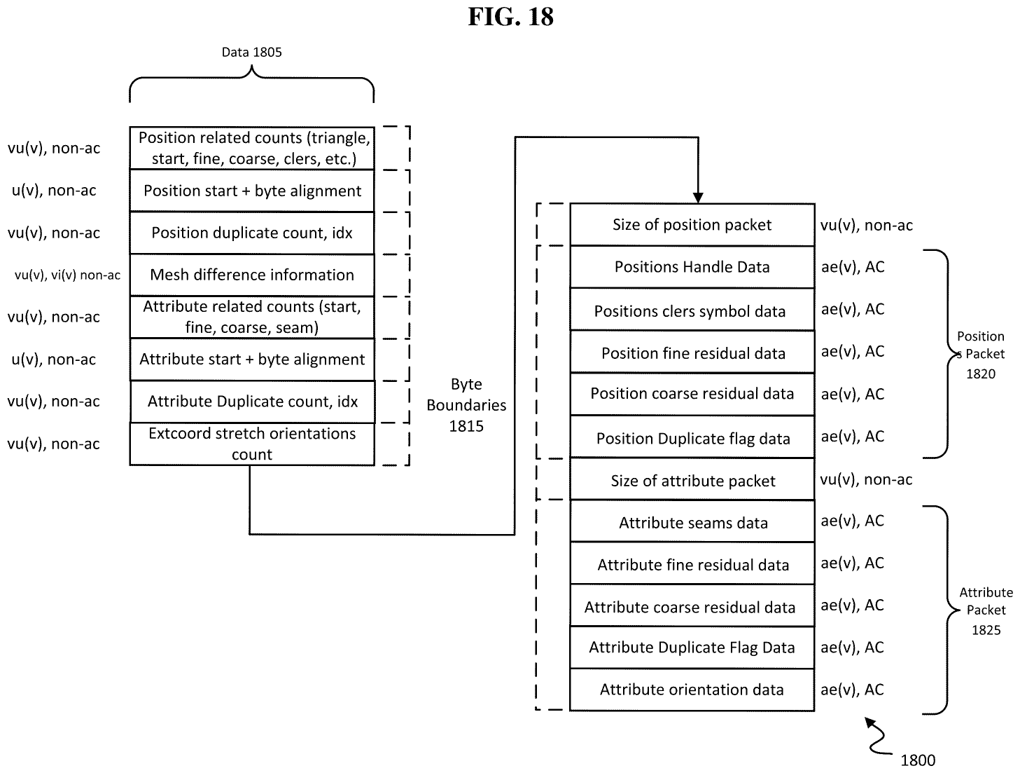

In another embodiment, FIG. 18 illustrates one possible embodiment where the mesh entropy enable flag (e.g., mesh_entropy_packet_enable_flag) is set to one ‘1’ and the non-AC coded syntax elements are coded before the AC-coded data. For example, all of the non-AC coded syntax elements corresponding to the position coding payload and the attribute coding payload are coded before all of the entropy packets corresponding to the position and attributes. That is, data 1805 can include the non-AC coded data associated with the position coding payload and the attribute coding payload before the positions packet 1820 and attribute packet 1825. In at least one embodiment, the size of the last attribute entropy packet is not signaled.

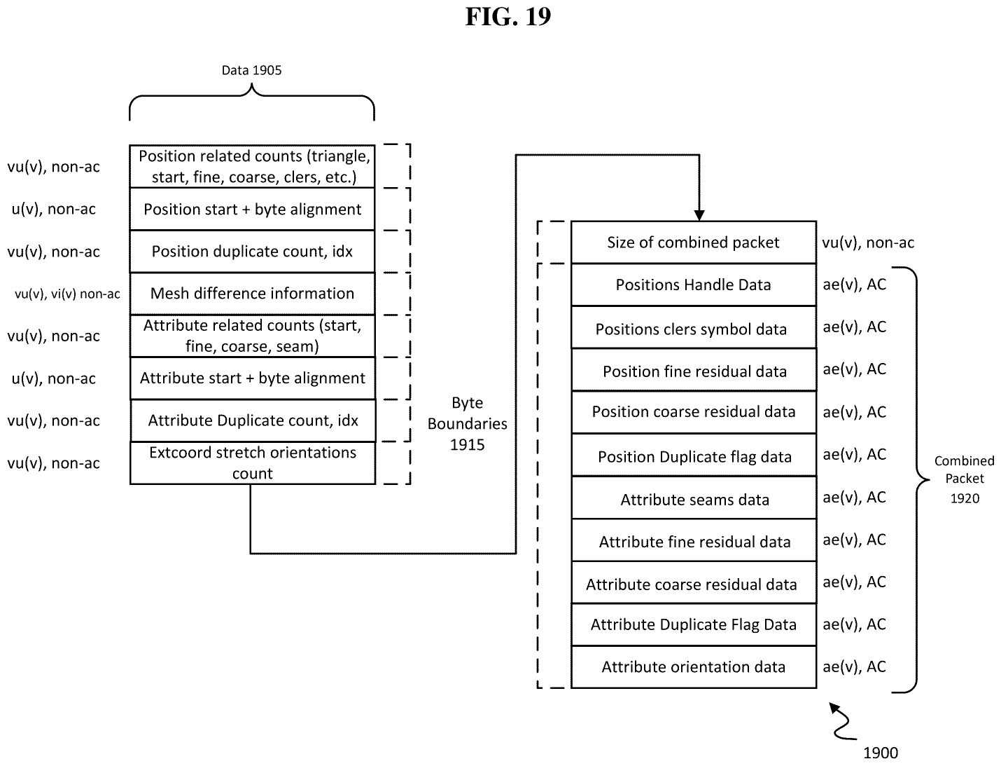

In still another embodiment, FIG. 19 illustrates one possible embodiment where the mesh entropy enable flag (e.g., mesh_entropy_packet_enable_flag) is set to zero ‘0’ and the non-AC coded syntax elements are coded before the AC-coded data. For example, all of the non-AC coded syntax elements corresponding to the position coding payload and the attribute coding payload are coded before the single AC-coded packet corresponding to the position and attributes. That is, data 1905 can include the non-AC coded data associated with the position coding payload and the attribute coding payload before the combined packet 1920. In at least one embodiment, a difference between FIG. 18 and FIG. 19 is packing all of the AC-coded data segments into a combined packet 1920 instead of a position packet 1820 and attribute packet 1825.

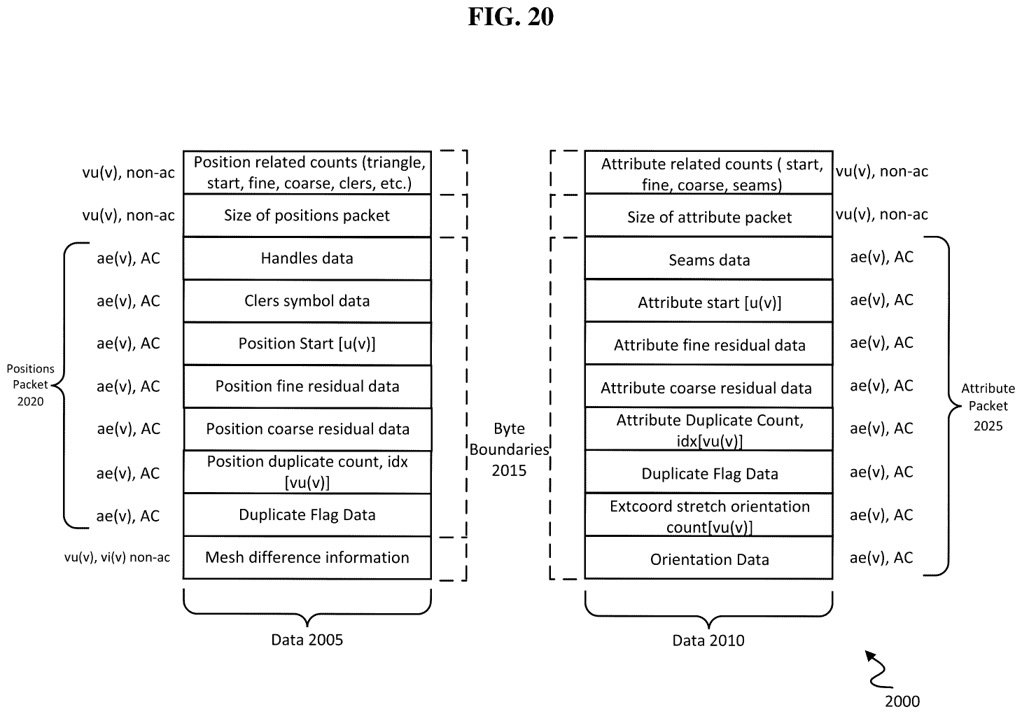

FIG. 20 illustrates example entropy packets in video-based dynamic mesh coding (V-DMC). The packets 2000 can be used to transmit one or more prediction errors (e.g., the prediction errors discussed with reference to FIGS. 6 and 7). In some embodiments, the prediction error associated with FIG. 20 is a geometry prediction error and a texture coordinate prediction error—e.g., for one texture of type MESH_ATTR_TEXCOORD. In at least one embodiment, data 2005 is associated with a geometry prediction error and data 2010 is associated with the texture coordinate prediction error. In other embodiments, other prediction errors are possible—e.g., FIG. 20 illustrates one example for clarification but is not limiting. In at least one embodiment, FIG. 20 illustrates a scenario when the mesh entropy flag is set at one ‘1.’

In one embodiment, an order of coding of non-arithmetic coding (AC) coded and AC-coded syntax elements follows a second format. In one example, a binarization of the second format is the same as the semantics and syntax elements described with reference to FIGS. 8-19. In one embodiment, however, bins (e.g., binary symbols) corresponding to the non-AC coded syntax elements between any two AC-coded data segments are coded using arithmetic coding in a bypass mode. That is, there is no separate byte alignment performed for non-AC coded syntax elements between any two AC-coded data segments because they are part of the AC-coded segment—e.g., the non-AC coded segments are packed in the AC-coded portion as well.

For example, as illustrated with reference to FIG. 20, non-AC coded data (e.g., position start[u(v)] and position duplicate count, idx[vu(v)]) for data 2005 (e.g., mesh position coding payload)) is packed in the positions packet 2020. In at least one embodiment, a binarization for the syntax elements which were previously non-AC coded but are now included in the AC-coded segment, are shown with square brackets. In at least one embodiment, the position start+byte alignment syntax is replaced with a position start[u(v)] syntax and is no longer byte aligned. In at least one embodiment, data 2010 (e.g., mesh attribute coding payload) can also include non-AC coded data in the AC-coded data segment—e.g., the data 2010 can include the non-AC coded attribute start [u(v)], the attribute duplicate count, idx[vu(v)], and the extcoord stretch orientation count [u(v)] are included in the attribute packet 2025.

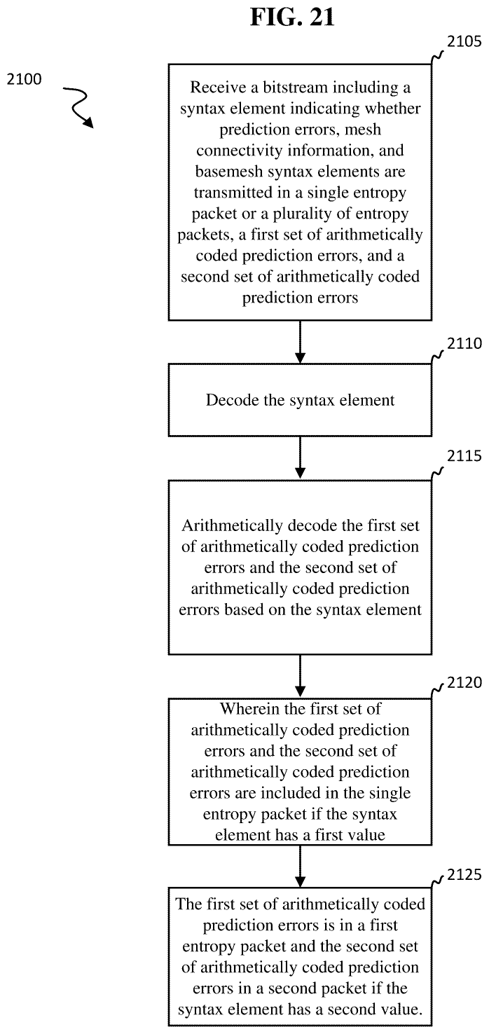

FIG. 21 is a flowchart showing operations of a basemesh decoder in accordance with an embodiment. In at least one embodiment, operations described with reference to FIG. 21 can be performed by a basemesh decoder) 525 as described with reference to FIG. 5.

At operation 2105, a processor of a mesh decoder receives a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors the mesh frame. In at least one embodiment, the syntax element is the entropy packet enable flag (e.g., entropy_packet_enable_flag) as described with reference to FIGS. 9-20. In at least some embodiments, the syntax element can have a first value or a second value. In some embodiments, the first value is a value zero ‘0’ and the second value is a value one ‘1.’ In some embodiments, the first set of arithmetically coded prediction errors is a geometry error and the second set of arithmetically coded prediction errors is an attribute error (e.g., texture coordinate prediction error, normal prediction error, material identification prediction error, etc.). In some embodiments, the first set of arithmetically coded prediction errors is at least one of a fine geometry prediction error or a coarse geometry prediction error. In other embodiment, the first set of arithmetically coded prediction errors is associated with a “fine” category and the second set of arithmetically coded prediction errors is associated with a “coarse” category. In other embodiments, the first set of arithmetically coded prediction errors includes at least the fine geometry prediction error and the coarse geometry prediction error. In some embodiments, the second set of arithmetically coded prediction errors is associated with an attribute prediction error. In at least one embodiment, the second set of arithmetically coded prediction errors includes at least one of a fine texture prediction error, a coarse texture prediction error, a fine material property prediction error, a coarse material property prediction error, a normal prediction error, or a material identification prediction error. In other embodiments, the second set of arithmetically coded prediction errors can include at least the fine texture coordinate error and the coarse texture coordinate error—e.g., the geometry and texture coordinates can be interleaved as described with reference to FIGS. 11 and 12.

At operation 2110, the processor can decode the syntax element. In one embodiment, the processor can determine a value for the syntax element based on the decoding.

At operation 2115, the processor can arithmetically decode the first set of arithmetically coded prediction errors and the second set of arithmetically coded prediction errors based on the syntax element. That is, as described with reference to FIG. 9, the syntax element can enable prediction errors to be transmitted in a single entropy packet or in multiple entropy packets. Accordingly, the decoder can decode the received bitstream based on the value of the syntax element—e.g., based on whether the first set of arithmetically coded prediction errors and the second set of arithmetically coded prediction errors are transmitted in the single packet or in multiple packets.

For example, at operation 2120, the first set of arithmetically coded prediction errors and the second set of arithmetically coded prediction errors are included in the single entropy packet if the syntax element has a first value—e.g., a value zero ‘0.’

In other examples, at operation 2125, the first set of arithmetically coded prediction errors is in a first entropy packet of the plurality of entropy packets and the second set of arithmetically coded prediction errors is in a second entropy packet of the plurality of entropy packets if the syntax element has a second value—e.g., a value one ‘1.’

In at least some embodiments, the bitstream can further include a second syntax element indicating a size of the first entropy packet if the syntax element has the second value—e.g., the bitstream can include a mesh_position_packet_size syntax element. In at least one embodiment, the processor can determine a variable (e.g., a buffer pointer (EntropyPacketPtr)) pointing to a current position in the first entropy packet based on the second syntax element, where the first set of arithmetically coded prediction errors is decoded based on the variable. That is, the bitstream can include the variable that indicates the current position.

In other embodiments, the bitstream can include a second syntax element indicating a size of the single entropy packet if the syntax element has the first value—e.g., the bitstream can include a mesh_all_packet_size syntax element. In at least one embodiment, the processor can determine a variable (e.g., buffer pointer (EntropyPacketPtr)) pointing to a current position in the single entropy packet based on the second syntax element, where the first set of arithmetically coded prediction errors and the second set of arithmetically coded prediction errors are decoded based on the variable. That is, the bitstream can include the variable that indicates the current position.

In some embodiments, a prediction error for a current vertex is determined by arithmetically decoding one of the first set of arithmetically coded prediction errors. For example, the processor is to determine a prediction value for the current vertex and determine a coordinate value of the current vertex based on the prediction error for the current vertex and the prediction value for the current vertex as described with reference to FIGS. 6 and 7.

In at least one embodiment, the bitstream further includes a second syntax element associated with the first set of arithmetically coded prediction errors (e.g., geometry_entropy_packet_enable) if the syntax element has the second value. In such embodiments, the processor is to decode the second syntax element and arithmetically decode the first set of arithmetically coded prediction errors based on the second syntax element. For example, the first set of arithmetically coded prediction errors are decoded without an arithmetic coding operation if the second syntax element has a third value (e.g., a value zero ‘0’). That is, there is no start of a new entropy packet before the geometry prediction error samples. In other examples, the first set of arithmetically coded prediction errors are decoded after decoding the arithmetic operation syntax element if the second syntax element has a fourth value—e.g., a value one ‘1.’ That is, there is a start of a new entropy packet before the geometry prediction error samples.

In at least one embodiment, the bitstream further includes a second syntax element associated with the second set of arithmetically coded prediction errors (e.g., material_attribute_entropy_packet_enable) if the syntax element has the second value. In such embodiments, the processor is to decode the second syntax element and arithmetically decode the second set of arithmetically coded prediction errors based on the second syntax element. For example, the second set of arithmetically coded prediction errors are decoded without an arithmetic operation if the second syntax element has a third value (e.g., a value zero ‘0’). That is, there is no start of a new entropy packet before the material attribute error samples. In other examples, the second set of arithmetically coded prediction errors are decoded after decoding the arithmetic operation syntax element if the second syntax element has a fourth value—e.g., a value one ‘1.’ That is, there is a start of a new entropy packet before the material attribute error samples.

In at least one embodiment, the bitstream can further include the mesh connectivity information and the additional basemesh syntax elements. In one embodiment, the mesh connectivity information includes mesh handle data and CLERS symbols. In some embodiments, the additional basemesh syntax elements includes material attribute scam information, duplicate vertices flag information, mesh attribute duplicate information, etc. In at least one embodiment, the additional basemesh syntax elements are all basemesh syntax elements other than prediction errors or mesh connectivity. In one embodiment, the processor is to decode the mesh connectivity information and the additional basemesh syntax elements. In at least one embodiment, the mesh connectivity information, the additional basemesh syntax elements, the first set of arithmetically coded prediction errors, and the second set of arithmetically coded prediction errors are included in the single entropy packet if the syntax elements has the first value. That is, when the syntax element is set to zero ‘0,’ all of the information related to geometry and material attributes can be transmitted in a single entropy packet. In such examples, this includes prediction errors as well as the mesh connectivity information and the additional basemesh syntax elements. In other embodiments, the mesh connectivity information is in a third entropy packet of the plurality of entropy packets and the additional basemesh syntax elements are in a fourth entropy packet of the plurality of entropy packets if the syntax element has the second value—e.g., each type of information is transmitted within their own respective entropy packets.

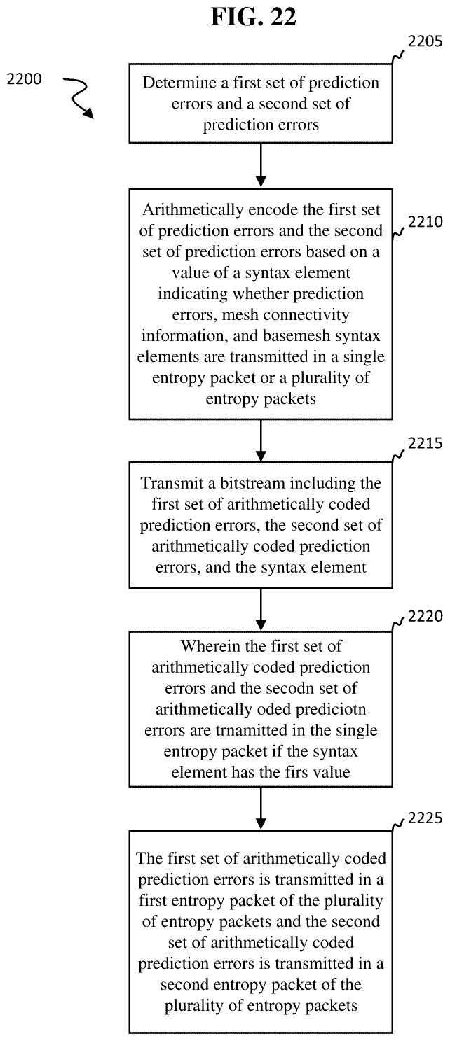

FIG. 22 is a flowchart showing operations of a basemesh encoder in accordance with an embodiment. In at least one embodiment, operations described with reference to FIG. 22 can be performed by a basemesh encoder 440 as described with reference to FIG. 4.

At operation 2205, a mesh encoder (e.g., a processor of the mesh encoder), determines a first set of prediction errors and a second set of prediction errors for the mesh frame. That is, as described with reference to FIGS. 6 and 7, a vertex position is predicted based on neighboring vertices in the same mesh frame. In some embodiments, the first set of prediction errors is a first type of prediction error and the second set of prediction errors is a second type of prediction error. For example, the first type of prediction error could be a geometry or position prediction error and the second type of prediction error could be an attribute position error (e.g., texture coordinate prediction error, normal prediction error, material identification prediction error, etc.). In some embodiments, the first set of prediction errors is associated with a “fine” category and the second set of prediction errors is associated with a “coarse” category. In at least one embodiment, the first set of prediction errors includes at least one of a fine geometry prediction error or a coarse geometry prediction error. In other embodiments, the first set of prediction errors can include both the fine geometry prediction error and the coarse geometry prediction error. In some embodiments, the second set of prediction errors is associated with an attribute prediction error. In at least one embodiment, the second set of prediction errors includes at least one of a fine texture prediction error, a coarse texture prediction error, a fine material property prediction error, a coarse material property prediction error, a normal prediction error, or a material identification prediction error. In other embodiments, the second set of prediction errors can include at least the fine texture coordinate error and the coarse texture coordinate error—e.g., the geometry and texture coordinates can be interleaved as described with reference to FIGS. 11 and 12.

At operation 2210, the processor arithmetically encodes the first set of prediction errors and the second set of prediction errors based on a value of a syntax element indicating whether prediction errors, mesh connectivity information, and additional basemesh syntax elements are transmitted in a single entropy packet or a plurality of entropy packets. In some embodiments, the syntax element can be an example of the entropy packet enable flag (e.g., entropy_packet_enable_flag) as described with reference to FIGS. 9-20. In at least some embodiments, the syntax element can have a first value or a second value. In some embodiments, the first value is a value zero ‘0’ and the second value is a value one ‘1.’

At operation 2215, the processor transmits a bitstream including the first set of arithmetically coded prediction errors, the second set of arithmetically coded prediction errors, and the syntax element. That is, as described with reference to FIG. 9, the syntax element can enable prediction errors, mesh connectivity information, and additional basemesh syntax elements to be transmitted in a single entropy packet or in multiple entropy packets. Accordingly, the encoder can encode the transmitted bitstream based on the value of the syntax element—e.g., based on whether the first set of arithmetically coded prediction errors and the second set of arithmetically coded prediction errors are transmitted in the single packet or in multiple packets.

For example, at operation 2220, the first set of arithmetically coded prediction errors and the second set of arithmetically coded prediction errors are transmitted in the single entropy packet if the syntax element has a first value—e.g., a value zero ‘0.’ That is, the first value can indicate the entropy packet enable flag is disabled. In such embodiments, the prediction error information is packed into a single entropy packet. Accordingly, when the processor encodes the syntax element to have the first value, the processor can pack the first set of arithmetically coded prediction errors and the second set of arithmetically coded prediction errors into the same entropy packet. In some embodiments, the processor can pack additional prediction errors into the one entropy packet—e.g., normal prediction error or material property prediction errors. In at least one embodiment, the processor does not pack an entropy header or an arithmetic operation (e.g., arithmetic start (ACS) or arithmetic end (ACE) as described with reference to FIGS. 8-13 when the syntax element has the first value.

In other examples, at operation 2225, the first set of arithmetically coded prediction errors is transmitted in a first entropy packet of the plurality of entropy packets and the second set of arithmetically coded prediction errors is transmitted in a second entropy packet of the plurality of entropy packets if the syntax element has a second value—e.g., a value one ‘1.’ In at least one embodiment, all attributes, elements, and syntax associated with the first set of arithmetically coded prediction errors in the same first entropy packet. In some embodiments, all attributes, elements, and syntax associated with the second set of arithmetically coded prediction errors are in the same second entropy packet.

In at least some embodiments, the processor is further to encode a variable (e.g., buffer pointer (EntropyPacketPtr)) pointing to a current position in the first entropy packet if the syntax element has the second value. In at least one embodiment, the processor transmits the variable in a second syntax element indicating a size of the first entropy packet, where the first set of prediction errors is encoded based on the variable—e.g., the bitstream can include a mesh_position_packet_size syntax element.

In at least some embodiments, the processor is further to encode a variable (e.g., buffer pointer (EntropyPacketPtr)) pointing to a current position in the single entropy packet if the syntax element has the first value. In at least one embodiment, the processor transmits the variable in a second syntax element indicating a size of the single entropy packet, where the first set of prediction errors and the second set of prediction errors is encoded based on the variable—e.g., the bitstream can include a mesh_all_packet_size syntax element.

In at least one embodiment, the processor can also encode a second syntax element (e.g., geometry_entropy_packet_enable) associated with the first set of prediction errors, where the processor is to arithmetically encode the first set of prediction errors based on encoding the second syntax value. In at least one embodiment, the processor can transmit the bitstream including the second syntax element. In at least one embodiment, the first set of arithmetically coded prediction errors is encoded without an arithmetic operation syntax element if the second syntax element has a third value. That is, there is no start of a new entropy packet before the geometry prediction error samples. In other embodiments, the first set of arithmetically coded prediction errors is encoded with the arithmetic operation syntax element if the second syntax element has a fourth value. That is, there is a start of a new entropy packet before the geometry prediction error samples.

In at least one embodiment, the processor can also encode a second syntax element (e.g., mesh_attribute_entropy_packet_enable) associated with the second set of prediction errors, where the processor is to arithmetically encode the second set of prediction errors based on encoding the second syntax value. In at least one embodiment, the processor can transmit the bitstream including the second syntax element. In at least one embodiment, the second set of arithmetically coded prediction errors is encoded without an arithmetic operation syntax element if the second syntax element has a third value. That is, there is no start of a new entropy packet before the mesh attribute prediction error samples. In other embodiments, the second set of arithmetically coded prediction errors is encoded with the arithmetic operation syntax element if the second syntax element has a fourth value. That is, there is a start of a new entropy packet before the mesh attribute prediction error samples.

In at least one embodiment, the processor is to determine the mesh connectivity information and the additional basemesh syntax elements. For example, the processor can determine mesh connectivity information such as mesh handle data and CLERs symbols and additional basemesh syntax elements such as material attribute seam data, duplicate vertices flags, mesh attribute duplicate information, etc. In at least one embodiment, the additional basemesh syntax elements can be all basemesh syntax elements other than the prediction errors and the mesh connectivity information. In at least one embodiment, the processor can transmit the bitstream including the mesh connectivity information and the additional basemesh syntax elements. In one embodiment, the mesh connectivity information, the additional basemesh syntax elements, the first set of arithmetically coded prediction errors, and the second set of arithmetically coded prediction errors are transmitted in the single entropy packet if the syntax element has the first value. That is, when the syntax element is set to zero ‘0,’ all of the information related to geometry and material attributes can be transmitted in a single entropy packet. In such examples, this includes prediction errors as well as the mesh connectivity information and the additional basemesh syntax elements. In other embodiments, the mesh connectivity information is transmitted in a third entropy packet of the plurality of entropy packets and the additional basemesh syntax element is transmitted in a fourth entropy packet of the plurality of entropy packets.

In some embodiments, utilizing a flag to transmit the prediction errors in a single packet or multiple packets can increase the overall compression efficiency of the system and enable bit savings. In some embodiments, a second syntax element (e.g., geometry_entropy_packet_enable or mesh_attribute_packet_enable) may not be explicitly transmitted. In such embodiments, the second syntax element is implicitly set depending on the mesh entropy enable flag (e.g., based on a value of mesh_entropy_packet_enable_flag).

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the disclosed technology. They are not intended and are not to be construed as limiting the scope of the disclosed technology in any manner. Although certain embodiments and examples have been provided, it will be apparent to those skilled in the art based on the disclosures herein that changes in the embodiments and examples shown may be made without departing from the scope of the disclosed technology.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus for decoding a mesh frame, comprising a processor configured to cause:
receive a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors for the mesh frame;
decode the syntax element; and
arithmetically decode the first set of arithmetically coded prediction errors and the second set of arithmetically coded prediction errors based on the syntax element,
wherein the first set of arithmetically coded prediction errors and the second set of arithmetically coded prediction errors are included in the single entropy packet if the syntax element has a first value, and
the first set of arithmetically coded prediction errors is in a first entropy packet of the plurality of entropy packets and the second set of arithmetically coded prediction errors is in a second entropy packet of the plurality of entropy packets if the syntax element has a second value.

2. The apparatus of claim 1, wherein the bitstream further includes a second syntax element indicating a size of the first entropy packet if the syntax element has the second value,
the processor is further configured to cause:
determine a variable pointing to a current position in the first entropy packet based on the second syntax element, wherein the first set of arithmetically coded prediction errors is decoded based on the variable.

3. The apparatus of claim 1, wherein the bitstream further includes a second syntax element indicating a size of the single entropy packet if the syntax element has the first value,
the processor is further configured to cause:
determine a variable pointing to a current position in the single entropy packet based on the second syntax element, wherein the first set of arithmetically coded prediction errors and the second set of arithmetically coded prediction errors are decoded based on the variable.

4. The apparatus of claim 1, wherein a prediction error for a current vertex is determined by arithmetically decoding one of the first set of arithmetically coded prediction errors, and
the processor is further configured to cause:
determine a prediction value for the current vertex; and
determine a coordinate value of the current vertex based on the prediction error for the current vertex and the prediction value for the current vertex.

5. The apparatus of claim 1, wherein the bitstream further includes a second syntax element associated with the first set of arithmetically coded prediction errors if the syntax element has the second value,
the processor is further configured to cause:
decode the second syntax element; and
arithmetically decode the first set of arithmetically coded prediction errors based on the second syntax element,
wherein the first set of arithmetically coded prediction errors are decoded without an arithmetic operation syntax element if the second syntax element has a third value; and
the first set of arithmetically coded prediction errors are decoded after decoding the arithmetic operation syntax element if the second syntax element has a fourth value.

6. The apparatus of claim 1, wherein the bitstream further includes a second syntax element associated with the second set of arithmetically coded prediction errors if the syntax element has the second value,
the processor is further configured to cause:
decode the second syntax element; and
arithmetically decode the second set of arithmetically coded prediction errors based on the second syntax element,
wherein the second set of arithmetically coded prediction errors are decoded without an arithmetic operation syntax element if the second syntax element has a third value; and
the second set of arithmetically coded prediction errors are decoded after decoding the arithmetic operation syntax element if the second syntax element has a fourth value.

7. The apparatus of claim 1, wherein the first set of arithmetically coded prediction errors is at least one of a fine geometry prediction error or a coarse geometry prediction error.

8. The apparatus of claim 1, wherein the second set of arithmetically coded prediction errors is at least one of a fine texture prediction error, a coarse texture prediction error, a fine material property prediction error, a coarse material property prediction error, a normal prediction error, or a material identification prediction error.

9. The apparatus of claim 1, wherein the first set of prediction errors includes at least a fine geometry prediction error and a coarse geometry prediction error and the second set of prediction errors includes at least a fine texture coordinate error and a coarse texture coordinate error.

10. The apparatus of claim 1, wherein the bitstream further includes the mesh connectivity information and the additional basemesh syntax elements,
the processor is further configured to cause:
decode the mesh connectivity information and the additional basemesh syntax elements,
wherein the mesh connectivity information, the additional basemesh syntax elements, the first set of arithmetically coded prediction errors, and the second set of arithmetically coded prediction errors are included in the single entropy packet if the syntax element has the first value, and
the mesh connectivity information is in a third entropy packet of the plurality of entropy packets and the additional basemesh syntax elements are in a fourth entropy packet of the plurality of entropy packets if the syntax element has the second value.

11. An apparatus for encoding a mesh frame, comprising a processor configured to cause:
determine a first set of prediction errors and a second set of prediction errors for the mesh frame;
arithmetically encode the first set of prediction errors and the second set of prediction errors based on a value of a syntax element indicating whether prediction errors, mesh connectivity information, and additional basemesh syntax elements are transmitted in a single entropy packet or a plurality of entropy packets; and
transmit a bitstream including the first set of arithmetically coded prediction errors, the second set of arithmetically coded prediction errors, and the syntax element,
wherein the first set of arithmetically coded prediction errors and the second set of arithmetically coded prediction errors are transmitted in the single entropy packet if the syntax element has a first value; and
the first set of arithmetically coded prediction errors is transmitted in a first entropy packet of the plurality of entropy packets and the second set of arithmetically coded prediction errors is transmitted in a second entropy packet of the plurality of entropy packets.

12. The apparatus of claim 10, wherein the processor is further configured to cause:
encode a variable pointing to a current position in the first entropy packet if the syntax element has the second value; and
transmit the variable in a second syntax element indicating a size of the first entropy packet, wherein the first set of prediction errors is encoded based on the variable.

13. The apparatus of claim 10, wherein the processor is further configured to cause:
encode a variable pointing to a current position in the single entropy packet if the syntax element has the first value; and
transmit the variable in a second syntax element indicating a size of the single entropy packet, wherein the first set of prediction errors and the second set of prediction errors are encoded based on the variable.

14. The apparatus of claim 10, wherein the processor is further configured to cause:
encode a second syntax element associated with the first set of prediction errors, wherein the processor is to arithmetically encode the first set of prediction errors based on encoding the second syntax element; and
transmit the bitstream including the second syntax element, wherein
the first set of arithmetically coded prediction errors is encoded without an arithmetic operation syntax element if the second syntax element has a third value; and
the first set of arithmetically coded prediction errors is encoded with the arithmetic operation syntax element if the second syntax element has a fourth value.

15. The apparatus of claim 10, wherein the processor is further configured to cause:
encode a second syntax element associated with the second set of prediction errors, wherein the processor is to arithmetically encode the second set of prediction errors based on encoding the second syntax element; and
transmit the bitstream including the second syntax element, wherein
the second set of arithmetically coded prediction errors is encoded without an arithmetic operation syntax element if the second syntax element has a third value; and
the second set of arithmetically coded prediction errors is encoded with the arithmetic operation syntax element if the second syntax element has a fourth value.

16. The apparatus of claim 10, wherein the first set of prediction errors includes at least one of a fine geometry prediction error or a coarse geometry prediction error.

17. The apparatus of claim 10, wherein the second set of prediction errors includes at least one of a fine texture prediction error, a coarse texture prediction error, a fine material property prediction error, a coarse material property prediction error, a normal prediction error, or a material identification prediction error.

18. The apparatus of claim 10, wherein the first set of prediction errors includes at least a fine geometry prediction error and a coarse geometry prediction error and the second set of prediction errors includes at least a fine texture coordinate error and a coarse texture coordinate error.

19. The apparatus of claim 10, wherein the processor is further configured to cause:
determine the mesh connectivity information and the additional basemesh syntax elements; and
transmit the bitstream including the mesh connectivity information and the additional basemesh syntax elements,
wherein the mesh connectivity information, the additional basemesh syntax elements, the first set of arithmetically coded prediction errors, and the second set of arithmetically coded prediction errors are transmitted in the single entropy packet if the syntax element has the first value; and
the mesh connectivity information is transmitted in a third entropy packet of the plurality of entropy packets and the additional basemesh syntax elements are transmitted in a fourth entropy packet of the plurality of entropy packets.

20. A method for decoding a mesh frame, comprising:
receiving, at a processor for decoding a mesh frame, a bitstream including a syntax element indicating whether prediction errors, mesh connectivity information, and additional basemesh syntax elements are transmitted in a single entropy packet or a plurality of entropy packets, a first set of arithmetically coded prediction errors, and a second set of arithmetically coded prediction errors for the mesh frame;
decoding the syntax element; and
arithmetically decoding the first set of arithmetically coded prediction errors and the second set of arithmetically coded prediction errors based on the syntax element,
wherein the first set of arithmetically coded prediction errors and the second set of arithmetically coded prediction errors are included in the single entropy packet if the syntax element has a first value; and
the first set of arithmetically coded prediction errors is in a first entropy packet of the plurality of entropy packets and the second set of arithmetically coded prediction errors is in a second entropy packet of the plurality of entropy packets if the syntax element has a second value.
